(19) United States
(12) Patent Application Publication
(10) Pub. No.: US 2026/0012107 A1
(43) Pub. Date: Jan. 8, 2026

(54) HYBRID TRACTION INVERTERS FOR ELECTRIC TRACTION MOTORS

(71) Applicant: Tesla, Inc., Austin, TX (US)

(72) Inventors: Maxwell Praglin, San Carlos, CA (US); Davide Cittanti, Berlin (DE); Mattia Guacci, Berlin (DE)

(21) Appl. No.: 19/248,879

(22) Filed: Jun. 25, 2025

Related U.S. Application Data
(60) Provisional application No. 63/668,016, filed on Jul. 5, 2024.

(51) Int. Cl. H02M 7/54; B60L 15/00

(52) U.S. Cl. CPC H02M 7/54; B60L 15/007

(57) ABSTRACT

A hybrid traction inverter can include a plurality of power switches configured to supply current to a motor of an electric vehicle and a controller. The plurality of power switches can include a first power switch and a second power switch, the first power switch and the second power switch being of different types. The controller can determine that a current associated with the plurality of power switches exceeds a threshold current. Responsive to determining that the current associated with the plurality of power switches exceeds the threshold current, the controller can control the plurality of power switches such that the first power switch turns on before the second power switch turns on during a switching cycle.

### CROSS-REFERENCE TO PRIORITY APPLICATION

This application claims priority to U.S. Provisional Patent Application No. 63/668,016, entitled “HYBRID TRACTION INVERTERS FOR ELECTRIC TRACTION MOTORS,” filed on Jul. 5, 2024, the technical disclosure of which is hereby incorporated by reference in its entirety and for all purposes.

### TECHNICAL FIELD

The present disclosure relates to electric power systems. More particularly, some embodiments of the present disclosure relate to traction inverter systems for driving electric motors, such as electric motors for vehicles.

### BACKGROUND

Technologies have been developed in recent years to build efficient and robust electric vehicles. These technologies include traction inverters and electric traction motors such as direct current (DC) motors, alternating current (AC) induction motors, permanent magnet motors, or the like. Permanent magnet motors can have higher efficiency compared with other types of motors.

Traction inverters have been designed to convert energy from a battery pack for powering motors that propel electric vehicles. Integrating traction inverters with traction motors, such as permanent magnet motors, may pose several technical challenges.

### SUMMARY OF CERTAIN INVENTIVE ASPECTS

The systems, methods and devices of this disclosure each have several innovative embodiments, no single one of which is solely responsible for all of the desirable attributes disclosed herein. Details of one or more implementations of the subject matter described in this specification are set forth in the accompanying drawings and the description below.

In some aspects, the techniques described herein relate to a hybrid traction inverter for controlling an electric motor including: a plurality of power switches configured to, in parallel, supply current to the electric motor of an electric vehicle, the plurality of power switches including a first power switch and a second power switch, the first power switch and the second power switch being of different types; and a controller configured to: determine that a current associated with the plurality of power switches exceeds a threshold current; and responsive to determining that the current associated with the plurality of power switches exceeds the threshold current, control the plurality of power switches such that the first power switch turns on before the second power switch turns on during a switching cycle.

In some aspects, the techniques described herein relate to a hybrid traction inverter, wherein the controller is configured to: determine that the current associated with the plurality of power switches is less than the threshold current; and responsive to determining that the current associated with the plurality of power switches is less than the threshold current, control the plurality of power switches such that the second power switch turns on before the first power switch turns on during a second switching cycle.

In some aspects, the techniques described herein relate to a hybrid traction inverter, further including a current sensor in communication with the controller, the current sensor configured to detect the current associated with the plurality of power switches.

In some aspects, the techniques described herein relate to a hybrid traction inverter, wherein the first power switch is an insulated gate bipolar transistor, and wherein the second power switch is a field effect transistor.

In some aspects, the techniques described herein relate to a hybrid traction inverter, wherein the first power switch is a silicon insulated gate bipolar transistor (Si IGBT), and wherein the second power switch is a silicon carbide metal oxide semiconductor field effect transistor (SiC MOSFET).

In some aspects, the techniques described herein relate to a hybrid traction inverter, wherein an emitter of the Si IGBT is connected to a source of the SiC MOSFET, and wherein a collector of the Si IGBT is connected to a drain of the SiC MOSFET.

In some aspects, the techniques described herein relate to a hybrid traction inverter, wherein the controller includes: a processing circuit configured to determine that the current associated with the plurality of power switches exceeds the threshold current, and generate a control signal and a pulse-width modulation (PWM) signal; and a gate drive integrated circuit (IC) configured to generate, based on the control signal and the PWM signal, (i) a first switching signal to switch the first power switch and (ii) a second switching signal to switch the second power switch, such that the first power switch is turned on before the second power switch is turned on during the switching cycle, and the first power switch is turned off after the second power switch is turned off during the switching cycle.

In some aspects, the techniques described herein relate to a hybrid traction inverter, wherein a rising edge of the first switching signal rises earlier than a rising edge of the second switching signal by an amount of time in a range from one hundred nanoseconds to ten microseconds during the switching cycle.

In some aspects, the techniques described herein relate to a hybrid traction inverter, wherein a falling edge of the first switching signal falls later than a falling edge of the second switching signal by an amount of time in a range from one hundred nanoseconds to ten microseconds during the switching cycle.

In some aspects, the techniques described herein relate to a hybrid traction inverter, wherein the PWM signal and the control signal are asynchronous to each other.

In some aspects, the techniques described herein relate to a hybrid traction inverter, wherein the first power switch is a silicon insulated gate bipolar transistor (Si IGBT), and the second power switch is a silicon carbide metal oxide semiconductor field effect transistor (SIC MOSFET), and wherein a gate of the Si IGBT is driven by the first switching signal, and a gate of the SiC MOSFET is driven by the second switching signal.

In some aspects, the techniques described herein relate to a hybrid traction inverter, wherein responsive to determining that the current associated with the plurality of power switches exceeds the threshold current, the controller is configured to control the plurality of power switches such that the first power switch turns off after the second power switch turns off during the switching cycle.

In some aspects, the techniques described herein relate to a hybrid traction inverter, wherein the threshold current is above 100 Amperes.

In some aspects, the techniques described herein relate to a hybrid traction inverter, wherein responsive to determining that the current associated with the plurality of power switches is less than the threshold current, the controller is to control the plurality of power switches such that the second power switch turns off after the first power switch turns off during the second switching cycle.

In some aspects, the techniques described herein relate to a hybrid traction inverter, further including a high current drive circuit configured to boost the first switching signal to drive a gate of the first power switch and boost the second switching signal to drive a gate of the second power switch.

In some aspects, the techniques described herein relate to a hybrid traction inverter, wherein the high current drive circuit and the gate drive IC are positioned on a printed circuit board (PCB), and wherein the high current drive circuit is positioned external to the gate drive IC.

In some aspects, the techniques described herein relate to a method of switching a plurality of power switches configured to, in parallel, supply current to a motor of an electric vehicle, wherein the plurality of power switches include a first power switch and a second power switch of different types, the method including: determining that a current associated with the plurality of power switches exceeds a threshold current; and responsive to determining that the current associated with the plurality of power switches exceeds the threshold current, controlling the plurality of power switches such that the first power switch turns on before the second power switch turns on during a switching cycle.

In some aspects, the techniques described herein relate to a method, further including: determining that the current associated with the plurality of power switches is less than the threshold current; and responsive to determining that the current associated with the plurality of power switches is less than the threshold current, controlling the plurality of power switches such that: (1) the second power switch turns on before the first power switch turns on during a second switching cycle, and (2) the second power switch turns off after the first power switch turns off during the second switching cycle.

In some aspects, the techniques described herein relate to a method, further including detecting the current associated with the plurality of power switches. 20. 21.

In some aspects, the techniques described herein relate to an electric vehicle including: a motor; and a hybrid traction inverter configured to drive the motor, the hybrid traction inverter including: a plurality of power switches configured to, in parallel, supply current to the motor, the plurality of power switches including a first power switch and a second power switch, the first power switch and the second power switch being of different types; and a controller configured to: determine that the current associated with the plurality of power switches exceeds a threshold current; and responsive to determining that the current associated with the plurality of power switches exceeds the threshold current, control the plurality of power switches such that: the first power switch turns on before the second power switch turns on during a switching cycle.

In some aspects, the techniques described herein relate to an electric vehicle, further including: a battery pack configured to supply power for the hybrid traction inverter to drive the motor.

In some aspects, the techniques described herein relate to an electric vehicle, wherein the motor is a permanent magnet motor.

In some aspects, the techniques described herein relate to a hybrid traction inverter including: a plurality of power switches including a first power switch and a second power switch, the first power switch and the second power switch being of different types; and a gate drive integrated circuit (IC) configured to generate a plurality of switching signals to switch the plurality of power switches, the gate drive IC including: a desaturation protection circuit configured to monitor a first voltage across a first terminal of the first power switch and a second terminal of the first power switch and provide desaturation protection for the first power switch based on monitoring the first voltage, wherein during a first turning-off process of the first power switch, the desaturation protection circuit monitors the first voltage during a subset of a time period of the first turning-off process.

In some aspects, the techniques described herein relate to a hybrid traction inverter, wherein the subset of the time period includes an end of the time period.

In some aspects, the techniques described herein relate to a hybrid traction inverter, wherein the subset of the time period of the first turning-off process is after an initial turn-off period of the first turning-off process.

In some aspects, the techniques described herein relate to a hybrid traction inverter, wherein the first power switch is an insulated gate bipolar transistor, and wherein the first terminal is a collector and the second terminal is an emitter.

In some aspects, the techniques described herein relate to a hybrid traction inverter, wherein the first power switch is a silicon insulated gate bipolar transistor (Si IGBT), and wherein the first terminal is a collector and the second terminal is an emitter.

In some aspects, the techniques described herein relate to a hybrid traction inverter, wherein a first transient spike appears on the first voltage outside of the subset of the time period of the first turning-off process.

In some aspects, the techniques described herein relate to a hybrid traction inverter, wherein the second power switch is a field effect transistor.

In some aspects, the techniques described herein relate to a hybrid traction inverter, wherein the second power switch is a silicon carbide metal oxide semiconductor field effect transistor (SiC MOSFET).

In some aspects, the techniques described herein relate to a hybrid traction inverter, wherein: the desaturation protection circuit is configured to monitor a second voltage across a drain of the second power switch and a source of the second power switch, wherein during a second turning-off process of the second power switch, the desaturation protection circuit monitors the second voltage after an initial turn-off event of the second turning-off process.

In some aspects, the techniques described herein relate to a hybrid traction inverter, wherein the desaturation protection circuit includes: a comparator configured to generate a comparator output based on the first voltage and a desaturation threshold voltage; and a desaturation circuit configured to trigger, based on the comparator output, a desaturation procedure for the first power switch, wherein the comparator output outside of the subset of the time period of the first turning-off process is set to a default value so as not to cause the desaturation circuit to trigger the desaturation procedure.

In some aspects, the techniques described herein relate to a hybrid traction inverter, wherein the gate drive IC further includes: a first Miller clamping circuit configured to mitigate a first glitch at a gate of the first power switch; and a second Miller clamping circuit configured to mitigate a second glitch at a gate of the second power switch, wherein an activation voltage of the first Miller clamping circuit is different from an activation voltage of the second Miller clamping circuit.

In some aspects, the techniques described herein relate to a hybrid traction inverter, wherein the gate drive IC further includes: a first turn-off circuit configured to turn off the first power switch according to a first turn-off process; and a second turn-off circuit configured to turn off the second power switch according to a second turn-off process, wherein the first turn-off process and the second turn-off process are different.

In some aspects, the techniques described herein relate to a hybrid traction inverter, wherein the first turn-off process is a normal turn-off and the second turn-off process is a soft turn-off.

In some aspects, the techniques described herein relate to a hybrid traction inverter, further including: a digital signal processor (DSP) configured to generate a control signal to reconfigure the first turn-off circuit or the second turn-off circuit.

In some aspects, the techniques described herein relate to a hybrid traction inverter, wherein the first turn-off circuit includes a plurality of resistors.

In some aspects, the techniques described herein relate to a drivetrain for an electric vehicle, the drivetrain including: a motor; and a hybrid traction inverter configured to drive the motor, the hybrid traction inverter including: a plurality of power switches including a first power switch and a second power switch, the first power switch and the second power switch being of different types; and a gate drive integrated circuit (IC) configured to generate a plurality of switching signals to switch the plurality of power switches, the gate drive IC including: a desaturation protection circuit configured to monitor a first voltage across a first terminal of the first power switch and a second terminal of the first power switch and provide desaturation protection for the first power switch based on monitoring the first voltage, wherein during a first turning-off process of the first power switch, the desaturation protection circuit monitors the first voltage during a subset of a time period of the first turning-off process.

In some aspects, the techniques described herein relate to a drivetrain, wherein the subset of the time period includes an end of the time period.

In some aspects, the techniques described herein relate to a drivetrain, wherein the subset of the time period is after an initial turn-off event of the first turning-off process.

In some aspects, the techniques described herein relate to a drivetrain, wherein the first power switch is an insulated gate bipolar transistor, and wherein the first terminal is a collector and the second terminal is an emitter.

In some aspects, the techniques described herein relate to a drivetrain, wherein the first power switch is a silicon insulated gate bipolar transistor (Si IGBT), and wherein the first terminal is a collector and the second terminal is an emitter.

In some aspects, the techniques described herein relate to a drivetrain, wherein the second power switch is a silicon carbide metal oxide semiconductor field effect transistor (SiC MOSFET).

In some aspects, the techniques described herein relate to a drivetrain, wherein a first transient spike appears on the first voltage outside of the subset of the time period of the first turning-off process.

In some aspects, the techniques described herein relate to an electric vehicle including: a motor; a battery pack configured to supply power to a hybrid traction inverter; and the hybrid traction inverter configured to drive the motor, the hybrid traction inverter including: a plurality of power switches including a first power switch and a second power switch, the first power switch and the second power switch being of different types; and a gate drive integrated circuit (IC) configured to generate a plurality of switching signals to switch the plurality of power switches, the gate drive IC including: a desaturation protection circuit configured to monitor a first voltage across a first terminal of the first power switch and a second terminal of the first power switch and provide desaturation protection for the first power switch based on monitoring the first voltage, wherein during a first turning-off process of the first power switch, the desaturation protection circuit monitors the first voltage during a subset of a time period of the first turning-off process.

In some aspects, the techniques described herein relate to an electric vehicle, wherein the first power switch is a silicon insulated gate bipolar transistor (Si IGBT) and the second power switch is a silicon carbide metal oxide semiconductor field effect transistor (SiC MOSFET).

In some aspects, the techniques described herein relate to a hybrid traction inverter configured to drive a permanent magnet motor, the hybrid traction inverter including: a plurality of power switches including a first power switch and a second power switch, the first power switch and the second power switch being of different types; and a fault management circuit configured to: detect a permanent magnet motor fault current flowing from or to the permanent magnet motor; and responsive to detecting the permanent magnet motor fault current, assert a fault signal to cause the first power switch to turn on before the second power switch turns on during a switching cycle, the first power switch having a higher current carrying capability than the second power switch.

In some aspects, the techniques described herein relate to a hybrid traction inverter, wherein the fault management circuit is configured to detect the permanent magnet motor fault current by at least detecting that the permanent magnet motor fault current exceeds a fault current threshold, and wherein the fault signal is asserted responsive to detecting that the permanent magnet motor fault current exceeds the fault current threshold.

In some aspects, the techniques described herein relate to a hybrid traction inverter, further including: a gate drive integrated circuit (IC) configured to generate a first switching signal to switch the first power switch and a second switching signal to switch the second power switch; and a digital signal processor (DSP) configured to generate a control signal, wherein: the gate drive IC is configured to generate the first switching signal and the second switching signal based on the fault signal independent of the control signal when the fault signal is asserted; and the gate drive IC is configured to generate the first switching signal and the second switching signal based on the control signal when the fault signal is unasserted.

In some aspects, the techniques described herein relate to a hybrid traction inverter, wherein when the fault signal is unasserted and a current associated with the plurality of power switches is below a threshold, the control signal causes the second power switch to be turned on before the first power switch is turned on during the switching cycle, and causes the second power switch to be turned off after the first power switch is turned off during the switching cycle.

In some aspects, the techniques described herein relate to a hybrid traction inverter, wherein the first power switch is an insulated gate bipolar transistor, and wherein the second power switch is a field effect transistor.

In some aspects, the techniques described herein relate to a hybrid traction inverter, wherein the first power switch is a silicon insulated gate bipolar transistor (Si IGBT), and wherein the second power switch is a silicon carbide metal oxide semiconductor field effect transistor (SiC MOSFET).

In some aspects, the techniques described herein relate to a hybrid traction inverter, wherein an emitter of the Si IGBT is connected to a source of the SiC MOSFET, and wherein a collector of the Si IGBT is connected to a drain of the SiC MOSFET.

In some aspects, the techniques described herein relate to a hybrid traction inverter, wherein a gate of the Si IGBT is driven by the first switching signal, and a gate of the SiC MOSFET is driven by the second switching signal.

In some aspects, the techniques described herein relate to a hybrid traction inverter, further including: a high current drive circuit configured to: boost the first switching signal to drive a gate of the first power switch; and boost the second switching signal to drive a gate of the second power switch.

In some aspects, the techniques described herein relate to a hybrid traction inverter, wherein the high current drive circuit and the gate drive IC are positioned on a printed circuit board (PCB), and wherein the high current drive circuit is positioned external to the gate drive IC.

In some aspects, the techniques described herein relate to a hybrid traction inverter, wherein the plurality of power switches are separate from or not directly mounted on the PCB.

In some aspects, the techniques described herein relate to a hybrid traction inverter, wherein a first portion of the gate drive IC and the DSP operate in a low voltage domain.

In some aspects, the techniques described herein relate to a hybrid traction inverter, wherein a second portion of the gate drive IC and the fault management circuit operate in a high voltage domain.

In some aspects, the techniques described herein relate to a drivetrain for an electric vehicle, the drivetrain including: a permanent magnet motor; and a hybrid traction inverter configured to drive the permanent magnet motor, the hybrid traction inverter including: a plurality of power switches including a first power switch and a second power switch, the first power switch and the second power switch being of different types; and a fault management circuit configured to: detect a permanent magnet motor fault current flowing from the permanent magnet motor; and responsive to detecting the permanent magnet motor fault current, assert a fault signal to cause the first power switch to turn on before the second power switch turns on during a switching cycle, the first power switch having a higher current carrying capability than the second power switch.

In some aspects, the techniques described herein relate to an electric vehicle including: a permanent magnet motor; a battery pack configured to supply power to a hybrid traction inverter; and the hybrid traction inverter configured to drive the permanent magnet motor, the hybrid traction inverter including: a plurality of power switches including a first power switch and a second power switch, the first power switch and the second power switch being of different types; and a fault management circuit configured to: detect a permanent magnet motor fault current flowing from the permanent magnet motor; and responsive to detecting the permanent magnet motor fault current, assert a fault signal to cause the first power switch to turn on before the second power switch turns on during a switching cycle, the first power switch having a higher current carrying capability than the second power switch.

In some aspects, the techniques described herein relate to an electric vehicle, wherein the hybrid traction inverter further includes: a gate drive integrated circuit (IC) configured to generate a first switching signal to switch the first power switch and a second switching signal to switch the second power switch; and a digital signal processor (DSP) configured to generate a control signal, wherein: the gate drive IC is configured to generate the first switching signal and the second switching signal based on the fault signal independent of the control signal when the fault signal is asserted; and the gate drive IC is configured to generate the first switching signal and the second switching signal based on the control signal when the fault signal is unasserted.

In some aspects, the techniques described herein relate to an electric vehicle, wherein when the fault signal is unasserted and a current associated with the plurality of power switches is below a threshold, the control signal causes the second power switch to turn on before the first power switch turns on during the switching cycle, and causes the second power switch to turn off after the first power switch turns off during the switching cycle.

In some aspects, the techniques described herein relate to an electric vehicle, wherein the first power switch is a silicon insulated gate bipolar transistor (Si IGBT), and wherein the second power switch is a silicon carbide metal oxide semiconductor field effect transistor (SiC MOSFET).

In some aspects, the techniques described herein relate to an electric vehicle, wherein an emitter of the Si IGBT is connected to a source of the SiC MOSFET, and wherein a collector of the Si IGBT is connected to a drain of the SiC MOSFET.

In some aspects, the techniques described herein relate to an electric vehicle, wherein a gate of the Si IGBT is driven by the first switching signal, and a gate of the SiC MOSFET is driven by the second switching signal.

In some aspects, the techniques described herein relate to an electric vehicle, wherein the hybrid traction inverter further includes: a high current drive circuit configured to: boost the first switching signal to drive the gate of the first power switch; and boost the second switching signal to drive the gate of the second power switch.

In some aspects, the techniques described herein relate to a hybrid traction inverter including: a plurality of power switches for supplying a current to a motor, the plurality of power switches including: a first power switch of a first type; a second power switch of a second type different from the first type; and a third power switch of the first type, wherein the first power switch and the third power switch are symmetrically positioned with reference to the second power switch in physical layout.

In some aspects, the techniques described herein relate to a hybrid traction inverter, wherein the first power switch and the third power switch are insulated gate bipolar transistors, and the second power switch is a field effect transistor.

In some aspects, the techniques described herein relate to a hybrid traction inverter, wherein the first power switch and the third power switch are silicon insulated gate bipolar transistors (Si IGBTs) and the second power switch is a silicon carbide metal oxide semiconductor field effect transistor (SiC MOSFET).

In some aspects, the techniques described herein relate to a hybrid traction inverter, wherein the first power switch and the second power switch are positioned around two opposing sides of the second power switch.

In some aspects, the techniques described herein relate to a hybrid traction inverter, wherein the hybrid traction inverter includes a dummy area free from power switches, the dummy area being between the third power switch and another power switch of the first type of the plurality of power switches.

In some aspects, the techniques described herein relate to a hybrid traction inverter, wherein the plurality of power switches include: a fourth power switch of the first type; a fifth power switch of the second type; and a sixth power switch of the first type, wherein the fourth power switch and the sixth power switch are positioned around two opposing sides of the fifth power switch.

In some aspects, the techniques described herein relate to a hybrid traction inverter, wherein the fourth power switch is the another power switch.

In some aspects, the techniques described herein relate to a hybrid traction inverter, wherein a ratio of quantity of Si IGBTs and SiC MOSFETs in the plurality of power switches is at least 2:1.

In some aspects, the techniques described herein relate to a hybrid traction inverter, wherein a ratio of quantity of Si IGBTs and SiC MOSFETs in the plurality of power switches is at least 3:1.

In some aspects, the techniques described herein relate to a hybrid traction inverter, wherein the first power switch, the third power switch, the fourth power switch, the sixth power switch, the second power switch, and the fifth power switch are in parallel with each other.

In some aspects, the techniques described herein relate to a hybrid traction inverter, wherein an emitter of the first power switch, an emitter of the third power switch, an emitter of the fourth power switch, an emitter of the sixth power switch, a source of the second power switch, and a source of the fifth power switch are connected with each other.

In some aspects, the techniques described herein relate to a hybrid traction inverter, wherein a collector of the first power switch, a collector of the third power switch, a collector of the fourth power switch, a collector of the sixth power switch, a drain of the second power switch, and a drain of the fifth power switch are connected with each other.

In some aspects, the techniques described herein relate to a hybrid traction inverter, further including: a gate drive integrated circuit (IC) configured to generate a plurality of switching signals to switch the plurality of power switches.

In some aspects, the techniques described herein relate to a hybrid traction inverter, further including: a digital signal processor (DSP) configured to generate a control signal to control the gate drive IC to generate the plurality of switching signals to switch the plurality of power switches.

In some aspects, the techniques described herein relate to a hybrid traction inverter, further including: a first decoupling impedance connected to a gate of the first power switch; a second decoupling impedance connected to a gate of the second power switch; and a third decoupling impedance connected to a gate of the third power switch, wherein the first decoupling impedance, the second decoupling impedance, and the third decoupling impedance are configured to mitigate voltage variations associated with parasitic inductances on the gate of the first power switch, the gate of the second power switch, and the gate of the third power switch.

In some aspects, the techniques described herein relate to a hybrid traction inverter, further including: a first balancing impedance connected to an emitter of the first power switch; and a second balancing impedance connected to an emitter of the third power switch, wherein the first balancing impedance and the second balancing impedance are configured to balance current flowing between the first power switch and the third power switch during switching.

In some aspects, the techniques described herein relate to a drivetrain for an electric vehicle, the drivetrain including: a motor; and a hybrid traction inverter configured to drive the motor, the hybrid traction inverter including: a plurality of power switches including: a first power switch of a first type; a second power switch of a second type different from the first type; and a third power switch of the first type, wherein the first power switch and the third power switch are symmetrically positioned with reference to the second power switch in physical layout.

In some aspects, the techniques described herein relate to a drivetrain, wherein the first power switch and the third power switch are insulated gate bipolar transistors, and the second power switch is a field effect transistor.

In some aspects, the techniques described herein relate to a drivetrain, wherein the first power switch and the third power switch are silicon insulated gate bipolar transistors (Si IGBTs) and the second power switch is a silicon carbide metal oxide semiconductor field effect transistor (SiC MOSFET).

In some aspects, the techniques described herein relate to a drivetrain, wherein the first power switch and the second power switch are positioned around two opposing sides of the second power switch.

In some aspects, the techniques described herein relate to a drivetrain, wherein the hybrid traction inverter includes a dummy area without accommodating any power switches.

In some aspects, the techniques described herein relate to an electric vehicle including: a motor; a battery pack configured to supply power to a hybrid traction inverter; and the hybrid traction inverter configured to drive the motor, the hybrid traction inverter including: a plurality of power switches including: a first power switch of a first type; a second power switch of a second type different from the first type; and a third power switch of the first type, wherein the first power switch and the third power switch are symmetrically positioned with reference to the second power switch in physical layout.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

Embodiments of the present disclosure are described with reference to the accompanying drawings, in which like reference characters reference like elements, and wherein:

FIG. 1A illustrates a perspective view of an example electric vehicle in accordance with some embodiments of the present disclosure.

FIG. 1B shows a schematic representation of the example electric vehicle of FIG. 1A in accordance with some embodiments of the present disclosure.

FIG. 2A illustrates an example schematic block diagram of a hybrid traction inverter and a portion of a motor in accordance with some embodiments of the present disclosure.

FIG. 2B illustrates another example schematic block diagram of a hybrid traction inverter in accordance with some embodiments of the present disclosure.

FIGS. 2C-2D illustrates example schematic block diagrams of a portion of the hybrid traction inverter of FIG. 2A in accordance with some embodiments of the present disclosure.

FIG. 3 illustrates example waveforms for controlling power switches of a hybrid traction inverter in accordance with some embodiments of the present disclosure.

FIGS. 4A-4B show example waveforms associated with power switches of a hybrid traction inverter in accordance with embodiments of the present disclosure.

FIG. 4C illustrates example waveforms associated with power switches of a hybrid traction inverter in accordance with embodiments of the present disclosure.

FIG. 5A illustrates a representation of a layout of power switches of a hybrid traction inverter in accordance with embodiments of the present disclosure.

FIG. 5B shows example schematics associated with power switches of a hybrid traction inverter in accordance with embodiments of the present disclosure.

FIG. 5C illustrates example waveforms associated with power switches of a hybrid traction inverter in accordance with embodiments of the present disclosure.

FIG. 6 is a flow diagram of an example process for controlling power switches of a hybrid traction inverter in accordance with embodiments of the present disclosure.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals and/or terms can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings. The headings are provided for convenience only and do not impact the scope or meaning of the claims.

Generally described, one or more aspects of the present disclosure relate to a hybrid traction inverter that utilizes both silicon insulated gate bipolar transistors (Si IGBTs) and silicon carbide metal oxide semiconductor field effect transistors (SiC MOSFETs) to drive motors (e.g., permanent magnet motors) of electric vehicles. More specifically, some embodiments of the present disclosure relate to one or more of control mechanisms, protection features, or physical layout adopted by the hybrid traction inverter to drive motors, thereby accomplishing efficient power conversion and fault-tolerant operations. At the same time, such hybrid traction inverters can be manufactured at competitive costs. Alternatively or additionally, the hybrid traction inverter may implement various fault protection mechanisms to mitigate the back electromotive force (back EMF) while being utilized to drive permanent magnet motors.

In certain inverter designs, only MOSFETs are used because MOSFETs offer higher efficiency (e.g., compared with IGBTs), especially at light loads, making MOSFETs attractive for maximizing vehicle range or reducing energy losses. However, SiC MOSFETs can be significantly more expensive than Si IGBTs (e.g., for a given current carrying capacity). Further, while SiC MOSFETs are efficient, SiC MOSFETs may have lower fault current handling capability and be less robust under high or fault load conditions. On the other hand, Si IGBTs can be less expensive and can handle higher fault currents, but are less efficient at light loads. Advantageously, the hybrid traction inverter can leverage above characteristics associated with SiC MOSFETs and Si IGBTs to lower manufacturing costs while maintaining efficiency and performance.

In some embodiments, the hybrid traction inverter uses less die area for SiC MOSFETs than that for Si IGBTs to lower manufacturing costs. The hybrid traction inverter may control timings for turning on and/or off of the SiC MOSFETs and the Si IGBTs differently, depending on driving conditions associated with a motor driven by the hybrid traction inverter. For example, when the motor demands current above a predetermined threshold, the hybrid traction inverter turns on Si IGBTs before turning on SiC MOSFETs and turns off Si IGBTs after turning off SiC MOSFETs. When the motor demands current below the predetermined threshold, the hybrid traction inverter turns on SiC MOSFETs before turning on Si IGBTs and turns off SiC MOSFETs after turning off Si IGBTs. In these cases, both the Si IBGTs and SiC MOSFETs can be utilized during a single switching cycle.

In some embodiments, the hybrid traction inverter implements various mechanisms to protect and achieve safe operations of the SiC MOSFETs and the Si IGBTs. By utilizing configurable circuits (e.g., various resistors of different resistances) for turning power devices on and/or off, the hybrid traction inverter may cause the SiC MOSFETs and the Si IGBTs to be turned off under different and reconfigurable speeds. For example, by utilizing configurable circuits (e.g., various resistors of different resistances coupled to the gates of the power devices), the hybrid traction inverter can control power devices to adjust the turn-off and turn-on transition times (i.e., the switching speeds) of the transistors. In some examples, resistors may be placed in series with the gate of one or more SiC MOSFETs and/or Si IGBTs, or as part of a pull-down network, to control the rate at which the gate voltage changes during switching events. By selecting appropriate resistor values or switching between different resistor configurations, the hybrid traction inverter can cause the SiC MOSFETs and the Si IGBTs to be turned off or on at different and reconfigurable speeds (e.g., different durations of the voltage transition at gates, which can affect how quickly the device switches from conducting to non-conducting (or vice versa). For example, the SiC MOSFETs can be turned off more slowly (e.g., soft turn-off) to reduce voltage overshoot and stress, while the Si IGBTs can be turned off more quickly (e.g., normal turn-off) to rapidly interrupt current flow under certain conditions. As used herein, normal turn-off and soft turn-off can refer to the rate at which the power device transitions from the conducting (on) state to the non-conducting (off) state, which can be determined by the slew rate of the gate voltage during turn-off. A normal turn-off can mean that the device is turned off rapidly (e.g., by applying a lower gate resistance). A soft turn-off can mean that the device is turned off more slowly (e.g., by increasing the gate resistance or otherwise controlling the gate drive to reduce the slew rate).

Alternatively or additionally, while turning off a semiconductor switch (e.g., a SiC MOSFET or a Si IGBT), the hybrid traction inverter may activate a masking mechanism to mask transient voltage spikes generated during a turn off process. In some examples, the masking mechanism may help avoiding false activation of protection features, such as desaturation protection, that rely on a measure of on-state voltage. As may be appreciated, desaturation protection may be desired in situations where power devices are carrying excessive current.

In some embodiments, to reduce or minimize voltages (e.g., voltages caused by parasitic inductances) across parasitic inductance of interconnects between SiC MOSFETs and Si IGBTs, the hybrid traction inverter employs specific placements and/or physically symmetric layout for semiconductor switches. For example, a SiC MOSFET may be positioned between two Si IGBTs to reduce voltages developed across interconnects, thereby improving one or more of reliability, efficiency, or power delivery capability of the hybrid traction inverter. Further, circuits or components that add impedance to terminals or connections to the SiC MOSFETs and Si IGBTs are deployed in the hybrid traction inverter to reduce or eliminate transient voltages across interconnects from affecting gate voltages of the SiC MOSFETs and Si IGBTs as well as balance current flow between devices (e.g., Si IGBTs) during switching transitions.

In some embodiments, the hybrid traction inverter controls switching of SiC MOSFETs and Si IGBTs according to particular switching vectors or waveforms based on a single command signal from fault detection circuitry (e.g., a fault management circuit) to handle back electromotive force (EMF) of a permanent magnet motor driven by the hybrid traction inverter. For example, the fault detection circuitry may cause Si IGBTs to be turned on before SiC MOSFETs are turned on, regardless of current demand from the permanent magnet motor. Advantageously, turning on the Si IGBTs before SiC MOSFETs without oversizing SiC MOSFETs helps to increase the inverter's capability to withstand the motor's back EMF.

Hybrid traction inverters can drive traction motors of electric vehicles. Hybrid traction inverters may utilize power transistors that include more than one type of power transistor, such as both silicon insulated gate bipolar transistors (Si IGBTs) and silicon carbide metal oxide semiconductor field effector transistors (SiC MOSFETs), to supply large currents to traction motors. Compared with each other, Si IGBTs have inexpensive bill of material (BOM) cost, lower power efficiency under light loads, and higher fault current handling capability. As used herein, fault current handling capability can refer to a power device's ability to safely conduct and withstand high currents (e.g., “fault currents”) that can occur during fault conditions (e.g., short circuits, overcurrent events, transients, back electromotive force (back EMF) from a motor) in a system. In contrast, SiC MOSFETs have more expensive BOM cost, higher power efficiency under light loads, and lower fault current handling capability. As such, to balance power efficiency, cost, and fault-tolerant capability, both Si IGBTs and SiC MOSFETs can be employed to provide current for driving traction motors.

Compared with non-hybrid or traditional inverters, utilizing Si IGBTs and SiC MOSFETs to drive motors can pose technical challenges. Such challenges can be due to the desire to provide distinct controlling and protecting mechanisms for ensuring efficient power conversion and fault-tolerant operations, in several aspects.

First, current demand from a traction motor and target efficiency may go up or down under different vehicle operating conditions. For example, under a level highway driving condition, current demand from the traction motor may not be as high as other driving conditions (e.g., moving uphill) and more power efficiency may be desired. In the highway driving condition, it may be preferred to rely more on SiC MOSFETs that have less switching loss to provide current to the traction motor. Yet, in some of the other driving conditions where current demand is higher and efficiency is less important, it may be preferred to rely more on switching Si IGBTs to provide current to the traction motor. As such, rigid or identical switching control of the Si IGBTs and SiC MOSFETs without taking operating conditions into consideration may lead to less satisfactory performance and/or power conversion efficiency. For example, when higher current handling is desired (e.g., during acceleration of a vehicle or fault conditions), multiple power devices can be used in parallel to safely conduct the desired current. For existing design, this would mean deploying several SiC MOSFETs in parallel with each other. But as noted above, SiC MOSFETs can be significantly more expensive and their efficiency gains may diminish as more die area is added. In contrast, Si IGBTs can be less expensive and can be in parallel with SiC MOSFETs to achieve the specified current handling capability at a lower cost. By combining Si IGBTs and SiC MOSFETs in parallel, the hybrid traction inverter can achieve a balance between cost and efficiency that would not be possible with an all-MOSFET approach, where scaling up with additional MOSFETs would be cost-prohibitive.

Second, it is typically desirable to integrate protection circuitry with power semiconductors to prevent operation failures of a power device (e.g., a MOSFET or an IGBT) from propagating to other power devices. For example, some protection circuitry can be deployed to implement various protection mechanisms such as protecting power devices from saturation, handling Miller turn on effects and power supply undershoot, and trigger turning off of devices. Because of the different characteristics, such as differing threshold turn on voltages of SiC MOSFETs and Si IGBTs, using identical protection circuitry (e.g., adopting identical Miller clamping circuit to trigger or activate clamping of power devices) to prevent operation failure of the SiC MOSFETs and Si IGBTs may result in sub-optimal performance.

Third, to support mass and low manufacturing cost production, there may be situations where multiple power devices (e.g., MOSFETs and IGBTs) are arranged in parallel to be interconnected with each other. Routing physical interconnections to connect these power devices may result in non-negligible parasitic capacitances and/or inductances, causing undesired effects. For example, while switching these power devices, current variations may generate voltages across the parasitic inductances. These voltages can affect one or more of reliability, efficiency, and/or power delivery capability of a traction inverter if left unhandled or unmitigated.

Additionally, to further improve power efficiency, it may be desirable to utilize hybrid traction inverters including Si IGBTs and SiC MOSFETs to drive permanent magnet motors. However, permanent magnet motors may suffer from issues related to back EMF. Back EMF may be generated while a permanent magnet motor is spinning at high speed. A voltage associated with back EMF may exceed voltage limits of one or more high voltage components (e.g., an inverter, a battery pack, or the like) of an electric vehicle to damage one or more of the high voltage components. As such, it may be desirable that a hybrid traction inverter appropriately controls its power semiconductors to prevent back EMF from flowing into one or more high voltage components and causing unwanted effects.

To address at least a portion of the above identified technical problems, some aspects of the disclosed technology relate to a hybrid traction inverter that controls switching of SiC MOSFETs and Si IGBTs to provide current for driving motors of electric vehicles. To meet current demand from a traction motor and facilitate efficient power conversion under varying operating conditions, the hybrid traction inverter may include a digital signal processor (DSP), a gate drive integrated circuit (IC), and power devices (e.g., a plurality of power switches) including both SiC MOSFETs and Si IGBTs. The DSP generates a pulse width modulated (PWM) signal and a switching sequence control signal. Based on the PWM signal and the switching sequence control signal, the gate drive IC can generate a first switching signal to control the Si IGBTs and a second switching signal to control the SiC MOSFETs.

In some embodiments, the hybrid traction inverter can include a current sensor to sense current (e.g., current provided by the power devices to the traction motor or current demand from the traction motor) associated with the power devices, and adjust the switching sequence control signal to change timings of the first switching signal and the second switching signal. For example, when the current sensed is below a predetermined threshold, the switching sequence control signal may be set to cause the gate drive IC to generate the second switching signal that rises earlier and falls later than the first switching signal such that the SiC MOSFETs are turned on earlier than the Si IGBTs in a switching cycle. When the current sensed exceeds the predetermined threshold, the switching sequence control signal may be set to cause the gate drive IC to generate the first switching signal that rises earlier and falls later than the second switching signal such that the Si IGBTs are turned on earlier than the SiC MOSFETs in a switching cycle. In some embodiments, the predetermined threshold may be on the order of 100 Amperes (A).

In some examples, instead of or in addition to using real-time current sensed between driving transistors and a motor or other approaches that can be influenced by the difference between a supply voltage and the back EMF of the motor, a switch control mechanism for transistors can also incorporate feed-forward control strategies. For example, a system may take into account anticipated operating conditions (e.g., a commanded acceleration event or an expected uphill drive), and proactively adjust the relative timing of turning on the SiC MOSFETs and Si IGBTs. By using information about the commanded current demand or predicted load conditions, the hybrid traction inverter can optimize the switching sequence in advance, rather than solely reacting to instantaneous current measurements. This feed-forward approach can improve responsiveness, efficiency, and overall system performance by aligning the inverter's control strategy with expected changes in motor load or vehicle dynamics.

Advantageously, by turning on Si IGBTs earlier than SiC MOSFETs and turning off Si IGBTs later than SiC MOSFETs under operating conditions that correspond to higher current demands from the traction motor, the higher current demands may be more likely to be satisfied. For example, under high current or fault conditions, the IGBTs may have superior fault current handling capabilities that enable IGBTs to safely conduct and withstand large or transient currents that could otherwise damage SiC MOSFETs. In these situations, a technical challenge can be delivering the desired current without risking device failure, and the lower efficiency of IGBTs at light loads can become less relevant. By turning on the IGBTs before the SiC MOSFETs and turning them off after the SiC MOSFETs, the hybrid traction inverter can ensure that the robust IGBTs are providing the high current during the most demanding portions of the switching cycle. This strategy can leverage the IGBTs' ability to handle high and fault currents, thereby increasing the likelihood that the inverter can meet the motor's current demands safely and reliably. By turning on SiC MOSFETs earlier than Si IGBTs and turning off SiC MOSFETs later than Si IGBTs under operating conditions that correspond to lower current demands from the traction motor, power conversion efficiency may be improved. For example, under lower current demands, the SiC MOSFET can be prioritized for switching because MOSFET can be more efficient at light loads, resulting in reduced switching and conduction losses and improved overall inverter efficiency. However, under these conditions, the IGBT can still be turned on, albeit for a shorter duration within the switching cycle. This control strategy can be advantageous because, in the disclosed hybrid inverter design, the SiC MOSFET can be intentionally sized smaller to reduce cost. By also turning on the IGBTs, current handling can be shared between the power devices, which helps prevent overstressing the smaller MOSFET and extends its operational life.

In some embodiments, during a switching cycle, the duration in which SiC MOSFETs and/or Si IGBTs are turned on may be on the order of 100 microseconds (μs) through the order of 1 μs. Depending on whether the sensed current exceeds the predetermined threshold, the switching sequence control signal may set rising and falling edges of the first switching signal and the second switching signal to cause the SiC MOSFETs to be turned on for a longer or a shorter duration than the Si IGBTs by delays on the order of 10 μs through 100 nanoseconds (ns) in a switching cycle. In some embodiments, under various current demands from the traction motor, the SiC MOSFETs and the Si IGBTs are all turned on during a switching cycle except that SiC MOSFETs are turned on longer than the Si IGBTs when a current demand is below the predetermined threshold, and that Si IGBTs are turned on longer than the SiC MOSFETs when a current demand exceeds the predetermined threshold.

In some embodiments, instead of generating multiple sets of control signals to individually control power devices, the DSP can generate a single set of control signals (e.g., the PWM signal and the switching sequence control signal) that will be used by the gate drive IC to generate the first switching signal and the second switching signal for controlling the SiC MOSFETs and Si IGBTs. Additionally, the PWM signal and the switching sequence control signal do not have to be generated by the same circuit or at the same time. For example, the DSP can generate a single PWM control signal without needing to create separate, transistor-specific control signals. A separate circuit or logic can be used to generate the switching sequence control signal or to modify the timing (and, if needed, the voltage levels) of the PWM signal for each transistor type (e.g., by adjusting the relative turn-on and turn-off times for the SiC MOSFET and IGBT based on a current threshold or other control criteria). Asynchronous control of these signals may be applicable. Further, the gate drive IC may be implemented using circuitry that does not introduce pulse width distortion during generation of the first switching signal and the second switching signal. Advantageously, the complexity of generating these control signals may be reduced.

Additionally, to protect power devices and achieve safe operations, the hybrid traction inverter may implement several protection features to prevent undesired operations or consequences. First, the hybrid traction inverter may implement a masking mechanism to mask transient voltage spikes across a power device (e.g., across a drain and source of a SIC MOSFET and/or across a collector and an emitter of a Si IGBT). More specifically, during the turning off of the power device, a transient voltage spike may be generated and appear as a positive change of voltage across the power device. This appearance of the positive change of voltage may falsely activate a desaturation protection circuit associated with the power device, resulting in an unwanted turn-off process. Using the masking mechanism, the transient voltage spike generated during the initial turn-off time period of the power device may be ignored. Advantageously, an undesired turn-off process may be prevented with the masking mechanism.

Second, instead of utilizing identical clamping circuits (e.g., Miller clamping circuits), the hybrid traction inverter may implement separate, independent, and/or distinct clamping circuits respectively for the SiC MOSFETs and the Si IGBTs. For example, a first Miller clamping circuit may be used to mitigate Miller turn on effects or glitches (e.g., voltage spikes) at gate of one or more SiC MOSFETs, and a second Miller clamping circuit may be used to mitigate Miller turn on effects or glitches at gate of one or more Si IGBTs. The first Miller clamping circuit may be activated when a gate voltage of a SiC MOSFET reaches a first threshold during turn-off switching, and the second Miller clamping circuit may be activated when a gate voltage of a Si IGBT reaches a second threshold different form the first threshold during turn-off switching. In some examples, the first Miller clamping circuit can the second Miller clamping circuit can operate under different voltage levels. Advantageously, separately mitigating Miller turn on effects or glitches using distinct Miller clamping circuits enable the hybrid traction inverter to activate clamping more effectively in view of differing characteristics of power devices.

Third, the hybrid traction inverter may turn off the SiC MOSFETs and the Si IGBTs at different rates or speeds. In some embodiments, the hybrid traction inverter may implement circuits that are reconfigurable to turn off the SiC MOSFETs more slowly than the Si IGBTs, or vice versa. For example, the hybrid traction inverter may utilize a first circuit for turning off the SiC MOSFETs, and a second circuit for turning off the Si IGBTs. Each of the first circuit and the second circuit may include a plurality of resistors in parallel. By adjusting or configuring connections associated with the first circuit, the first circuit may exhibit a first impedance that, when coupled with the SiC MOSFETs, causes the SiC MOSFETs to be turned off more slowly. By adjusting or configuring connections associated with the second circuit, the second circuit may exhibit a second impedance (e.g., different from the first impedance) that, when coupled with the Si IGBTs, causes the Si IGBTs to be turned off more quickly. Advantageously, the capability of turning off the SiC MOSFETs and the Si IGBTs at reconfigurable and differing speeds may enable better protection on the power devices or associated circuitry in view of different amount of current supplied by the power devices.

In some embodiments, the hybrid traction inverter may employ several physical layout and circuit design techniques to handle effects associated with parasitic capacitance and/or inductance resulted from physical interconnections between parallel power devices. As noted above, routing physical interconnections to connect these power devices may result in non-negligible parasitic capacitances and/or inductances, causing undesired effects such as voltage variations across the parasitic inductances that can adversely affect reliability, efficiency, and/or power delivery capability of the hybrid traction inverter. One technique used by the hybrid traction inverter to reduce or minimize voltage developed across interconnected power devices is through physical symmetry in layout of the power devices.

For example, a SiC MOSFET may be placed or sandwiched between two Si IGBTs in layout. By positioning Si IGBTs symmetrically on opposing sides of the SiC MOSFET, voltages developed across interconnects between the SiC MOSFET and the Si IGBTs can be reduced and/or become more balanced. More specifically, during high current variation (e.g., high dI/dt) switching events, voltage across the parasitic inductances of interconnects between IGBTs and the MOSFET may be reduced. Further, differences between switching waveforms applied to the Si IGBTs may be reduced or eliminated because of the physical symmetry in layout associated with power devices. In some embodiments, the number Si IGBTs relative to the SiC MOSFETs may bear a 2:1 ratio (e.g., two Si IGBTs accompany one SiC MOSFET). Advantageously, through the specific placement and choice of relative number and/or area between SiC MOSFETs and Si IGBTs, power losses and/or thermal stress associated with the parasitic inductances between interconnects may be mitigated or controlled. Additionally, in some embodiments, some of the area for placing the Si IGBTs and the SiC MOSFETs may be left empty or unoccupied. In these embodiments, the unoccupied area may provide flexibility for scaling current driving capability of the hybrid traction inverter through deploying additional Si IGBTs and/or SIC MOSFETs into unoccupied area.

In some embodiments, to mitigate mutual interferences between interconnected power devices, some electrical components (e.g., resistors, impedances, or the like) may be included to connect with terminals of power devices. For example, for a pair of a Si IGBT and a SiC MOSFET connected in parallel with each other, one or more decoupling resistors may be connected to terminals of each of the Si IGBT and the SiC MOSFET to reduce mutual interferences on the gate of each power device. More specifically, a first decoupling impedance (e.g., a resistor) may be connected to a gate of the Si IGBT, and a second decoupling impedance (e.g., a resistor) may be connected to a gate of the SiC MOSFET. The first decoupling impedance and the second decoupling impedance may reduce or eliminate common mode voltages at the gates of the Si IGBT and the SiC MOSFET from converting into differential mode voltages at the gates, thereby reducing interferences between the Si IGBT and the SiC MOSFET.

Additionally and/or optionally, a third decoupling impedance (e.g., a resistor) may be connected to an emitter of the Si IGBT, and a fourth decoupling impedance (e.g., a resistor) may be connected to a source of the SiC MOSFET. The third decoupling impedance and the fourth decoupling impedance may prevent common mode voltages at the emitter of the Si IGBT and the source of the SiC MOSFET from converting into differential mode voltages at the emitter and the source, thereby reducing interferences between the Si IGBT and the SiC MOSFET. Advantageously, mutual interferences between the SiC MOSFET and the Si IGBT caused by common mode voltages at terminals of the SiC MOSFET and the Si IGBT may be mitigated without utilizing independent power supply voltages for the SiC MOSFET and the Si IGBT.

In some embodiments, besides connecting a decoupling impedance to an emitter of each of the Si IGBTs, a balancing impedance may be inserted in series with the decoupling impedance for each of the Si IGBTs to balance current between the Si IGBTs during switching transitions. The balancing impedance may have a resistance smaller than a resistance of the decoupling impedance. In some examples, the balancing impedance may have a resistance on the order of 10 Ohms.

Further, to achieve desirable power efficiency while ensuring system operation safety, the hybrid traction inverter may be utilized to drive permanent magnet motors. As noted above, if not properly handled, energy (e.g., permanent magnet motor fault current) associated with back EMF may flow from a permanent magnet motor to a battery pack and/or other electrical components of an electric vehicle, which can cause damage and/or other undesired effects. One technique adopted by the hybrid traction inverter to ensure safe system operations in the face of back EMF issues is to increase power devices capability in handling permanent magnet motor fault current. Rather than increasing sizes of SiC MOSFETs, the hybrid traction inverter increases area for accommodating Si IGBTs and/or number of Si IGBTs to increase capability for handling permanent magnet motor fault current. The hybrid traction inverter may advantageously increase more capability for handling permanent magnet motor fault current and incur less additional BOM cost by employing the technique of adding area and/or number of Si IGBTs rather than oversizing SiC MOSFETs.

In some embodiments, the hybrid traction inverter may utilize a fault management circuit to handle permanent magnet motor fault current. Upon detecting a fault (e.g. inability to properly control motor current the fault management circuit may generate a single or a single set of command signals for controlling turning on of the SiC MOSFETs and the Si IGBTs to prevent the permanent magnet motor fault current from flowing into other parts of the high voltage system of the electric vehicle.

For example, the fault management circuit may generate a single command signal to the gate drive IC for controlling timings of turning on the SiC MOSFETs and the Si IGBTs. The single command signal may overwrite or take precedence over the switching sequence control signal sent to the gate drive IC from the DSP discussed above. More specifically, upon detecting a rising edge of the single command signal, the gate drive IC may generate the first switching signal and the second switching signal as noted above to respectively control the Si IGBTs and the SiC MOSFETs such that the Si IGBTs are turned on before the SiC MOSFETs, regardless of values of the switching sequence control signal discussed above. As such, the Si IGBTs may be turned on before the SiC MOSFETs are turned on (and/or turned off after the SiC MOSFETs are turned off) even when current provided by the Si IGBTs and the SiC MOSFETs does not exceed the predetermined threshold (e.g., a value on the order of hundred Amperes). Advantageously, by turning on the Si IGBTs before the SiC MOSFETs, the power devices may have higher capability to conduct the permanent magnet motor fault current such that the permanent magnet motor fault current may not flow to the battery pack or other electrical components of the electric vehicle to cause damage.

In some embodiments, the gate drive IC may be partitioned into two power domains (e.g., a high voltage domain and a low voltage domain). The high voltage domain may interface with power devices (e.g., the Si IGBTs and the SiC MOSFETs) while the low voltage domain may interface with the DSP to receive the PWM signal and the switching sequence control signal noted above. In some implementations, when the single command signal from the fault management circuit rises to a logic high value, the gate drive IC may generate the first switching signal and the second switching signal to respectively control the Si IGBTs and the SiC MOSFETs without utilizing the PWM signal and the switching sequence control signal. In these implementations, the gate drive IC may control the Si IGBTs and the SiC MOSFETs based on the single command signal and ignore or override the PWM signal and the switching sequence control signal from the DSP. Additionally and/or optionally, the fault management circuit may be deactivated when the hybrid traction inverter is utilized to drive other types of motors (e.g., AC induction motor) other than permanent magnet motors because permanent magnet motor fault current may not occur in situations where the other types of motors are used.

In some embodiments, high current drive circuits may be deployed between the power devices and the high voltage domain of the gate drive IC. The high current drive circuit may boost the first switching signal and the second switching signal generated by the gate drive IC to more effectively drive the power devices, in particular when the power devices have large gate charges. The high current drive circuit may be deployed on a printed circuit board (PCB) and outside the gate drive IC. The gate drive IC may be deployed on the PCB, and the power devices may be deployed outside the PCB. By deploying the high current drive circuit outside the gate drive IC, the hybrid traction inverter may advantageously relieve or reduce thermal stress inside the gate drive IC compared with situations where the high current drive circuit is deployed inside the gate drive IC. Additionally, noise associated with the high current drive circuit is less likely to cause interferences or signal integrity issues within the gate drive IC. Additionally, the high current drive circuit may have higher scalability without being constrained by physical design constraints associated with the gate drive IC. For example, it may be easier to independently scale a first portion of the high current drive circuit for driving the SiC MOSFETs, and a second portion of the high current drive circuit for driving the Si IGBTs.

Although aspects of the present disclosure will be described with regard to illustrative components, interactions, and routines, one skilled in the relevant art will appreciate that one or more aspects of the present disclosure may be implemented in accordance with various environments, various electric vehicles, traction inverter architectures, and the like. Similarly, references to specific devices, such as a hybrid traction inverter, can be considered to be general references and not intended to provide additional meaning or configurations for the individual hybrid traction inverter. Still, further, illustrations and exemplary configurations are not intended to be limited and should not be construed as limiting the scope of the present disclosure. Additionally, the examples are intended to be illustrative in nature and should not be construed as limiting.

### Example Electric Vehicle

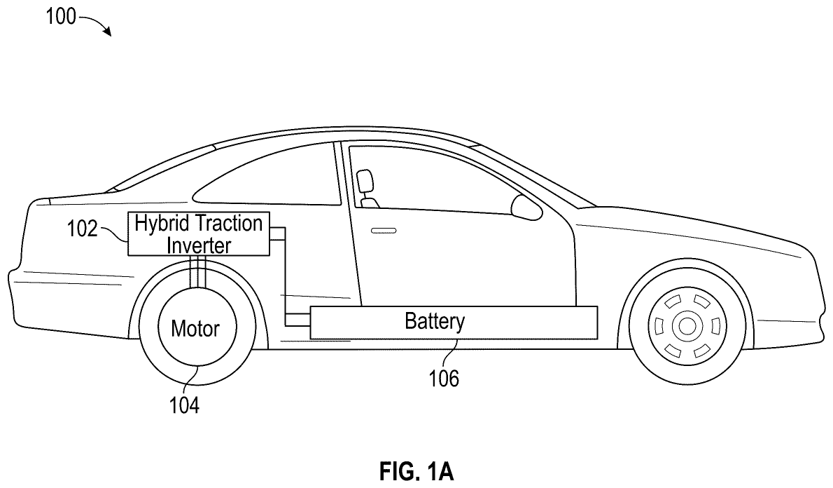

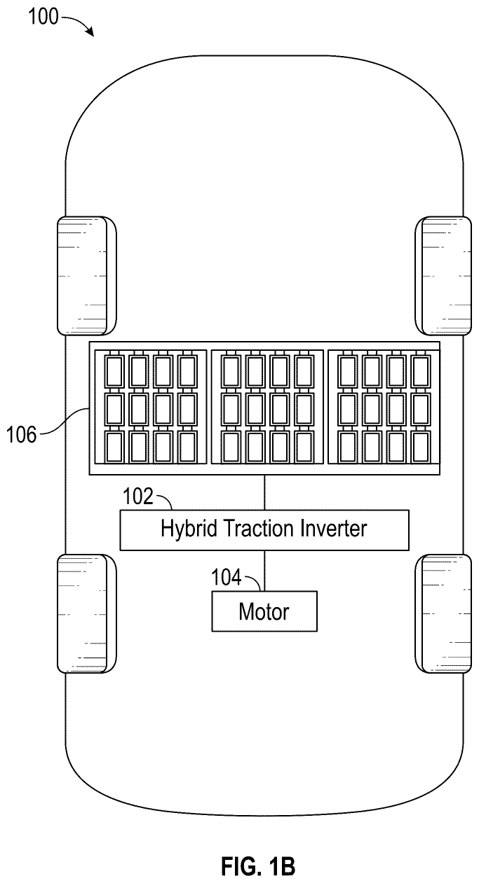

FIG. 1A illustrates a perspective view of an example electric vehicle 100 in accordance with some embodiments of the present disclosure. The electric vehicle 100 includes at least a hybrid traction inverter 102, a motor 104, and a battery 106. The battery 106 may include one or more battery packs, where an individual battery pack may include a plurality of battery cells. The configuration of the battery 106 can be determined based on specific applications. The battery 106 may provide electric power to the hybrid traction inverter 102, which in turn supplies electric power to the motor 104.

The motor 104 may be any suitable type of electric motor, such as AC or DC permanent magnet motor, AC induction motor, AC brushless motor, or the like. In some embodiments, the motor 104 may be a three-phase AC permanent magnet motor. The motor 104 may generate a drive force or a torque for the electric vehicle 100 based on electric power supplied from the battery 106 through the hybrid traction inverter 102.

In some embodiments, the hybrid traction inverter 102 may convert direct current (DC) into alternating current (AC). For example, the hybrid traction inverter 102 may convert DC into three-phase AC current and supplies the three phase AC current to the motor 104. The hybrid traction inverter 102 may utilize different types (e.g., Si-based, SiC-based, SiGe-based, GaN-based, GaAs-based, or the like) of power switches to supply current to the motor 104. For example, the hybrid traction inverter 102 may utilize silicon insulated gate bipolar transistors (Si IGBTs) and silicon carbide metal oxide semiconductor field effect transistors (SiC MOSFETs) to supply current to the motor 104 of the electric vehicle 100. The hybrid traction inverter 102 may also μse one or more of junction field effect transistors (JFETs), insulated-gate field effect transistors (IGFETs), integrated gate-commutated thyristors (IGCT), high electron mobility transistors (HEMTs), or the like to supply current to the motor 104.

FIG. 1B shows a representation of the example electric vehicle 100 of FIG. 1A in accordance with some embodiments of the present disclosure. As shown in FIG. 1B, the motor 104, the hybrid traction inverter 102, and the battery 106 may be communicatively coupled and may form at least a portion of a drivetrain or a powertrain of the electric vehicle 100.

### Example Hybrid Traction Inverter

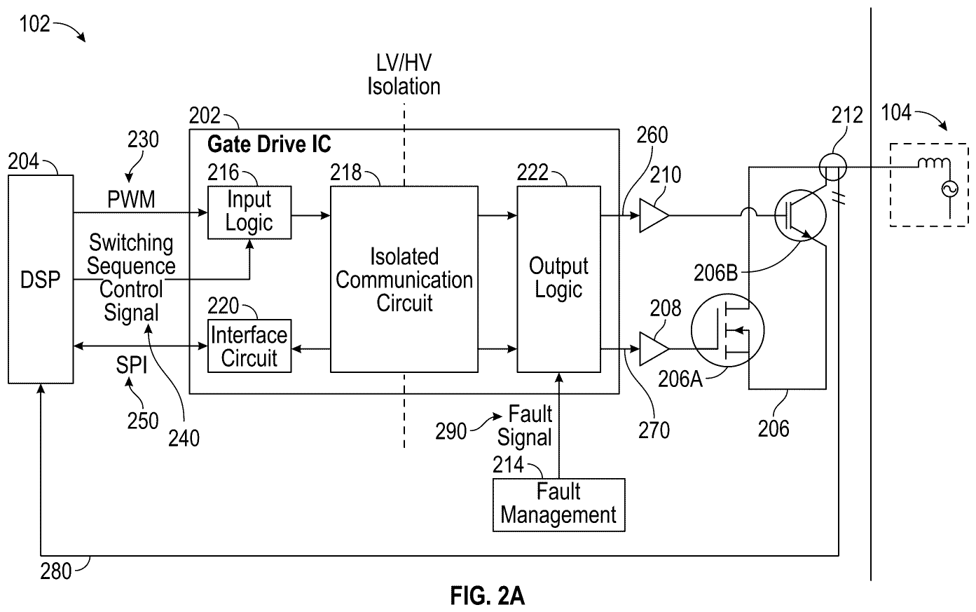

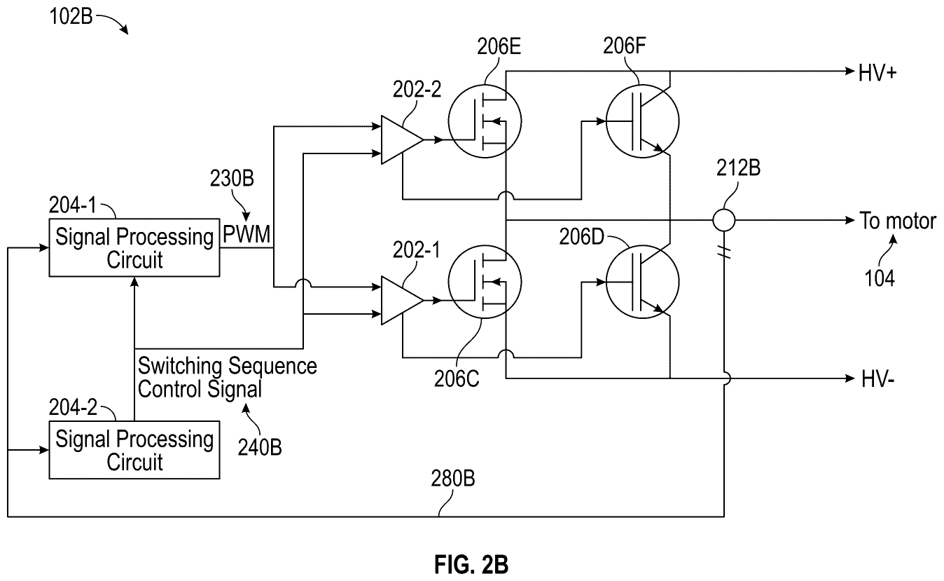

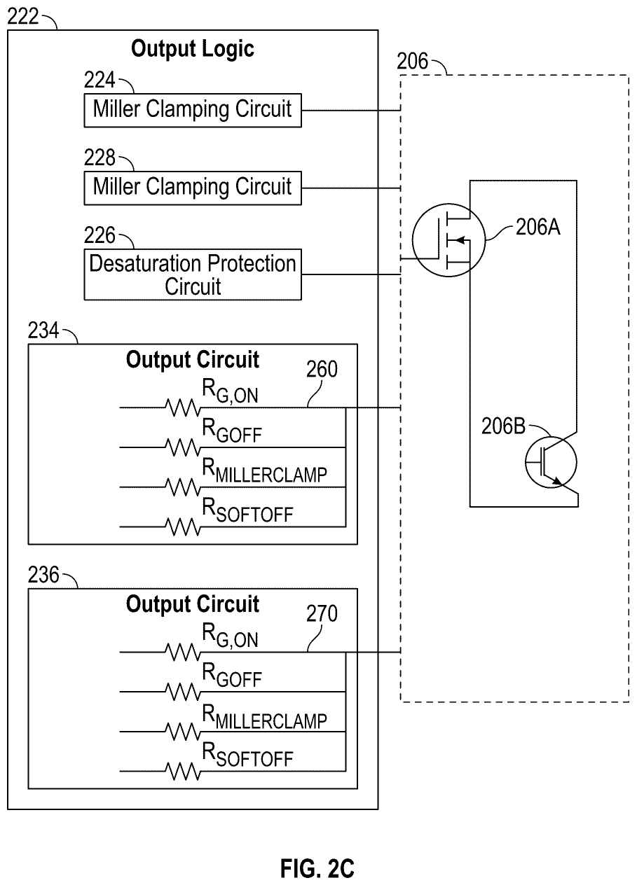

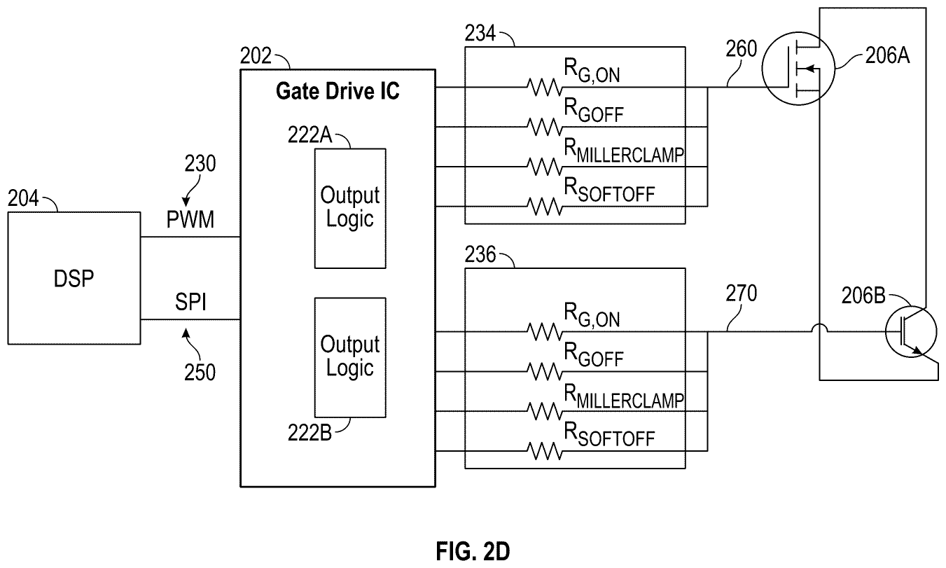

FIG. 2A illustrates an example schematic block diagram of the hybrid traction inverter 102 and a portion of the motor 104 in accordance with some embodiments of the present disclosure. For example, FIG. 2A may show one of three phases of the motor 104, where the motor 104 is a permanent magnet motor. The motor 104 may receive current from the hybrid traction inverter 102.

As shown in FIG. 2A, the hybrid traction inverter 102 may include a digital signal processor (DSP) 204, a gate drive integrated circuit (IC) 202, a plurality of power switches 206, a current sensor 212, and a fault management circuit 214. A controller of the hybrid traction inverter 102 can include the DSP 204 and the gate drive IC 202. The hybrid traction inverter 102 may include a high current drive circuit 208 and a high current drive circuit 210 that are deployed between the gate drive IC 202 and the plurality of power switches 206.

The DSP 204 may be embodied as any type of single-core, single-thread, multi-core, and/or multi-thread processor capable of performing functions as described herein. The DSP 204 may be embodied as a microprocessor, central processing unit (CPU), microcontroller, or other processor or processing/controlling circuit. The DSP 204 may generate pulse width modulated (PWM) signal 230 and a switching sequence control signal 240 to the gate drive IC 202. The switching sequence control signal 240 may indicate a switching sequence or order between turning the SiC MOSFET 206A and the Si IGBT 206B on and/or off. The DSP 204 may communicate with the gate drive IC 202 through interface signals 250.

The gate drive IC 202 may be communicatively coupled to the DSP 204. The gate drive IC 202 may generate switching signals 260 and 270 to drive the plurality of power switches 206 based on the PWM signal 230 and the switching sequence control signal 240 received from the DSP 204. The gate drive IC 202 may be embodied as a semiconductor integrated circuit, such as a complementary metal-oxide semiconductor (CMOS) integrated circuit. As shown in FIG. 2A, the gate drive IC 202 may include an input logic 216, an isolated communication circuit 218, an interface circuit 220, and an output logic 222. The input logic 216 may receive the PWM signal 230 and the switching sequence control signal 240 from the DSP 204. Based on the PWM signal 230 and the switching sequence control signal 240, the input logic 216, the isolated communication circuit 218 and the output logic 222 may generate the switching signal 260 and the switching signal 270 to respectively switch the Si IGBT 206B and the SiC MOSFET 206A with differing timing. The interface circuit 220 may communicate with the DSP 204 through an interface (e.g., SPI, I²C, etc.) using the interface signals 250 for setting configurations and/or facilitating diagnostics functionalities associated with the DSP 204 and the gate drive IC 202.

As shown in FIG. 2A, some of the gate drive IC 202 may operate in a low voltage domain and some of the gate drive IC 202 may operate in a high voltage domain. For example, the input logic 216, the interface circuit 220, and a portion of the isolated communication circuit 218 may operate in the low voltage domain. The output logic 222 and a portion of the isolated communication circuit 218 may operate in the high voltage domain.

As noted above, the plurality of power switches 206 may include different types (e.g., Si-based, SiC-based, SiGe-based, GaN-based, GaAs-based, or the like) of power switches to supply current to the motor 104. In some embodiments, the plurality of power switches 206 may include one or more Si IGBTs and one or more SiC MOSFETs. In the hybrid traction inverter 102 of FIG. 2A, the plurality of power switches 206 includes a SiC MOSFET 206A and a Si IGBT 206B. The SiC MOSFET 206A and the Si IGBT 206B may be connected in parallel, with their gates driven by different switching signals. More specifically, a drain of the SiC MOSFET 206A may be connected to a collector of the Si IGBT 206B, a source of the SiC MOSFET 206A may be connected to an emitter of the Si IGBT 206B, a gate of the Si IGBT 206B may be driven by a switching signal 260 generated by the gate drive IC 202, and a gate of the SiC MOSFET 206A may be driven by a switching signal 270 generated by the gate drive IC 202. It should be noted that any other suitable number (e.g., two, four, six, eight, ten, twelve) of SiC MOSFETs 206A and/or Si IGBTs 206B can be included in the plurality of power switches 206, and the plurality of power switches 206 may utilize different numbers of SiC MOSFET 206A and Si IGBT 206B to supply current to the motor 104.

The current sensor 212 can sense a current supplied to the motor 104 by the plurality of power switches 206 to generate a sensing signal 280 indicative of the current. The current sensor 212 may transmit the sensing signal 280 to the DSP 204 for further processing.

The hybrid traction inverter 102 can include a fault management circuit 214 for fault protection. The fault management circuit 214 can be implemented when the motor 104 is a permanent magnet motor. The fault management circuit 214 may detect presence of permanent magnet motor fault current flowing to the plurality of power switches 206 from the motor 104. The fault management circuit 214 can create a single command that applies a static switching vector to both the Si IGBTs 206B and the SiC MOSFETs 206A. This command can be generated without involvement of the DSP 204. In other examples, the fault current may flow to the permanent magnet motor or other components. More specifically, the direction of the fault current (e.g., whether flowing from the permanent magnet motor to the hybrid traction inverter 102 or to a battery) can depend on the specific circuit configuration, such as whether a power switch is on the high side or low side of the hybrid traction inverter. In the context of permanent magnet motors, an overvoltage condition due to back EMF can result in fault current flowing into certain components, including the hybrid traction inverter 102 and potentially a battery pack, if not properly managed. Advantageously, through techniques disclosed herein, the hybrid traction inverter 102 can handle fault currents (e.g., regardless of the current path) that may arise from overvoltage conditions caused by back EMF generated by the permanent magnet motor, thereby safely managing and dissipating these fault currents to protect components or circuits from damage due to back EMF events.

Responsive to detecting the permanent magnet motor fault current, the fault management circuit 214 may assert a fault signal 290. The fault signal 290, when asserted, may cause the gate drive IC 202 to adjust the switching signal 270 and the switching signal 260 to control the plurality of power switches 206 for preventing the permanent magnet motor fault current from flowing into the battery 106 of the electric vehicle 100. In some examples, Si IGBT(s) and SiC MOSFET(s) of the plurality of power switches 206 can be connected in parallel to supply current to the motor, allowing both types of devices to share current during operation. Under certain operating conditions (e.g., high current demand or fault current events), the Si IGBT can be turned on before the SiC MOSFET to leverage Si IGBT's superior fault current handling capability. Under other conditions (e.g., lower current or efficiency-prioritized conditions), the SiC MOSFET may be turned on before the Si IGBT to improve efficiency.

In some embodiments, when the fault signal 290 is asserted to indicate the presence of permanent magnet motor fault current, the output logic 222 may generate the switching signal 260 and switching signal 270 independent of the PWM signal 230 and the switching sequence control signal 240. Accordingly, the fault signal 290, when asserted, can override other control of the plurality of power switches 206. In these embodiments, the output logic 222 may generate the switching signal 260 and the switching signal 270 such that the Si IGBTs 206B are turned on before the SiC MOSFETs 206A are turned on even if the switching sequence control signal 240 indicates that the SiC MOSFETs 206A should be turned on before the Si IGBTs 206B are turned on. This can ensure that Si IGBTs 206B are turned on before SiC MOSFETs 206A in a motor fault scenario. Motor fault currents can be orders of magnitude higher than the RMS current in normal driving at the same speed. Due to the higher current carrying capability of the Si IGBTs 206B, the fault management circuit 214 can turn on the Si IGBTs 206B before the SiC MOSFETs 206A in the presence of motor fault currents. In other words, in response to a detected fault, the fault management circuit can ensure that SiC MOSFETs 206A are not activated without a corresponding parallel-path one of Si IGBTs 206B to be active for high current handling reasons.

As noted above, the high current drive circuit 208 and the high current drive circuit 210 may be deployed between the gate drive IC 202 and the plurality of power switches 206. The high current drive circuit 208 may boost the switching signal 270 to drive the SiC MOSFET 206A. The high current drive circuit 210 may boost the switching signal 260 to drive the Si IGBT 206B.

In some embodiments, based on the sensing signal 280, the DSP 204 and the gate drive IC 202 may coordinate to generate the switching signal 260 and the switching signal 270 to drive the plurality of power switches 206. The DSP 204 and the gate drive IC 202 may control timings for turning on and turning off the SiC MOSFET 206A and the Si IGBTs 206B differently, depending on driving conditions associated with the electric vehicle 100 that includes the hybrid traction inverter 102. For example, in response to the sensing signal 280 indicating that a current supplied to the motor 104 (or a current demand from the motor 104) is above a predetermined threshold, the DSP 204 and the gate drive IC 202 may cause the Si IGBTs 206B to be turned on before the SiC MOSFETs 206A are turned on, and cause the Si IGBTs 206B to be turned off after the SiC MOSFETs 206A are turned off during switching cycles. On the other hand, in response to the sensing signal 280 indicating that a current supplied to the motor 104 (or a current demand from the motor 104) is below the predetermined threshold, the DSP 204 and the gate drive IC 202 may cause the SiC MOSFETS 206A to be turned on before the Si IGBTs 206B are turned on, and cause the SiC MOSFETs 206A to be turned off after the Si IGBTs 206B are turned off during switching cycles.

FIG. 2B illustrates an example schematic block diagram of a hybrid traction inverter 102B in accordance with some embodiments of the present disclosure. The hybrid traction inverter 102B can function the same as or similarly to the hybrid traction inverter 102 to drive the motor 104 except that (1) a PWM signal 230B and a switching sequence control signal 240B are respectively generated by a signal processing circuit 204-1 and a signal processing circuit 204-2, and (2) the hybrid traction inverter 102B shows two sets of power switches that can be respectively controlled by a gate drive IC 202-1 and a gate drive IC 202-2. More specifically, rather than using the DSP 204 to generate both the PWM signal 230 and the switching sequence control signal 240, the signal processing circuit 204-1 generates the PWM signal 230B, and the signal processing circuit 204-2 generates the switching sequence control signal 240B. Further, a first set of power switches (e.g., a SiC MOSFET 206C and a Si IGBT 206D) are controlled by the gate drive IC 202-1, and a second set of power switches (e.g., a SiC MOSFET 206E and a Si IGBT 206F) are controlled by the gate drive IC 202-2. As shown in FIG. 2B, a current sensor 212B can sense a current supplied to the motor 104 by the first set of power switches and the second set of power switches to generate a sensing signal 280B indicative of the current. Based on the sensing signal 280B, the signal processing circuit 204-1 and the signal processing circuit 204-2 can generate the PWM signal 230B and the switching sequence control signal 240B. Although FIG. 2B illustrates two pairs of power switches that each include a MOSFET and an IGBT driven by a gate drive IC, any suitable number of pairs of power switches, such as but not limited to 4 pairs, 6 pairs, or 8 pairs, can be implemented for a particular application.

FIG. 2C illustrates an example block diagram of the output logic 222 of the hybrid traction inverter 102 in accordance with some embodiments of the present disclosure. As shown in FIG. 2C, the output logic 222 may include a Miller clamping circuit 224, a Miller clamping circuit 228, a desaturation protection circuit 226, an output circuit 234, and an output circuit 236. The output logic 222 may implement various protection features on the plurality of power switches 206 to prevent undesired operations or damages to the plurality of power switches 206.

In some embodiments, the desaturation protection circuit 226 may implement a masking mechanism to mask transient voltage spikes across the drain and the source of the SiC MOSFET 206A and/or across the collector and an emitter of the Si IGBT 206B so as to reduce or eliminate undesired turn-off process. For example, during the turning off of the SiC MOSFET 206A, a transient voltage spike may be generated to initially appear a positive (or negative) change of voltage across the drain and the source of the SiC MOSFET 206A. This appearance of the positive change of voltage may falsely activate the desaturation protection circuit 226, resulting in unwanted turn-off process. Incorporating the masking mechanism, the transient voltage spike generated during the initial turn-off time period of the power device may not falsely activate the desaturation protection circuit 226.

In some embodiments, the Miller clamping circuit 224 may be used to mitigate Miller turn on effects or glitches (e.g., voltage spikes) at a gate of the SiC MOSFET 206A. The Miller clamping circuit 228 may be used to mitigate Miller turn on effects or glitches at a gate of the Si IGBT 206B. The Miller clamping circuit 224 may be activated when the gate voltage of the SiC MOSFET 206A reaches a first threshold during turn-off switching, and the Miller clamping circuit 228 may be activated when the gate voltage of Si IGBT 206B reaches a second threshold different form the first threshold during turn-off switching.

In some embodiments, the output circuit 234 and the output circuit 236 may allow the gate drive IC 202 to turn off the SiC MOSFET 206A and the Si IGBT 206B at different rates or speeds. The output circuit 234 and the output circuit 236 may be configurable to turn off the SiC MOSFETs 206A more slowly than the Si IGBTs 206B, or vice versa. As shown in FIG. 2C, each of the output circuit 234 and the output circuit 236 includes four resistors. By adjusting or configuring connections associated with the output circuit 234, the output circuit 234 may exhibit a first impedance that, when coupled with the SiC MOSFET 206A, causes the SiC MOSFET 206A to be turned off more slowly than the Si IGBT 206B. By adjusting or configuring connections associated with the output circuit 236, the output circuit 236 may exhibit a second impedance (e.g., different from the first impedance) that, when coupled with the Si IGBT 206B, causes the Si IGBT 206B to be turned off more quickly than the SiC MOSFET 206A.

Although the output circuit 234 and the output circuit 236 are illustrated to be within the output logic 222 in FIG. 2D, in some other embodiments the output circuit 234 and/or the output circuit 236 can be implemented external to the gate drive IC 202, for example, as illustrated in FIG. 2D. More specifically, FIG. 2D shows that the output circuit 234 is implemented outside the gate drive IC 202 and is driven by an output logic 222A of the gate drive IC 202, and the output circuit 236 is implemented outside the gate drive IC 202 and is driven by an output logic 222B of the gate drive IC 202.

### Example Switching Signal Waveforms

The hybrid traction inverter 102 can μse less SiC MOSFET die area than Si IGBT die area. This can be due to the SiC MOSFET die area being more expensive and providing diminishing returns in efficiency when more area is added. At certain operating points (e.g., highway driving) where efficiency is significant and the motor 104 does not demand high phase current, low SiC MOSFET 206A switching loss is preferred. Accordingly, the SiC MOSFET 206A can be responsible for switching the phase current of the hybrid traction inverter 102. The smaller SiC MOSFET die area alone may not be capable of carrying the peak current of the hybrid traction inverter 102, so the Si IGBT 206B can switch phase current at higher power operating points.

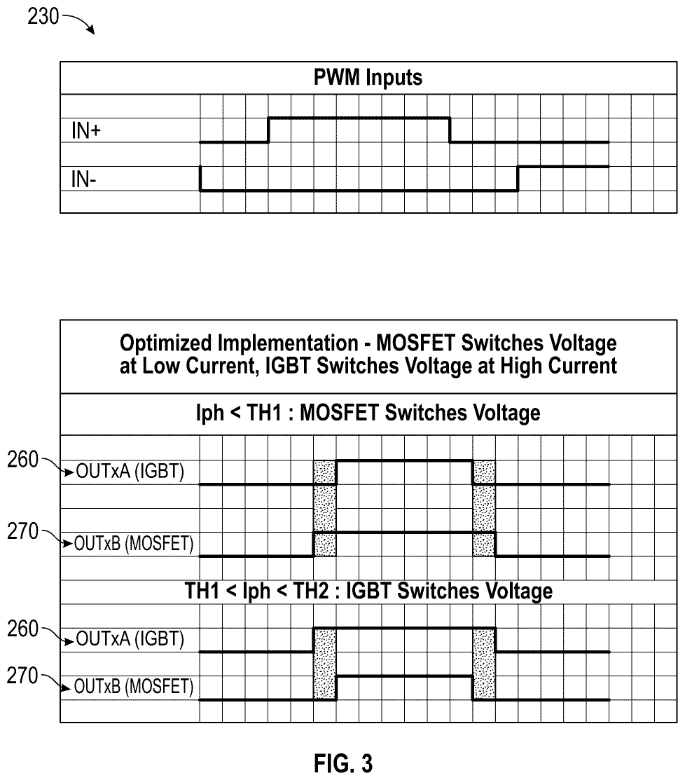

FIG. 3 illustrates example waveforms for controlling the plurality of power switches 206 of the hybrid traction inverter 102 in accordance with some embodiments of the present disclosure. More specifically, FIG. 3 shows voltage waveforms of the PWM signal 230, the switching signal 260, and the switching signal 270 during a switching cycle. The switching signal 260 and the switching signal 270 are shown under low current and high current conditions.

As illustrated in FIG. 3, when a current (e.g., sensed by the current sensor 212) provided to the motor 104 is less than a threshold (e.g., 210 A), the DSP 204 may set the switching sequence control signal 240 to cause the gate drive IC 202 to generate the switching signal 270 and the switching signal 260 such that the switching signal 270 rises earlier and falls later than the switching signal 260 during the switching cycle. Thus, the SiC MOSFET 206A is turned on earlier and turned off later than the Si IGBT 206B. Accordingly, under a low current condition, the SiC MOSFET 206A can be on for more of a switching cycle than the Si IGBT 206B.

When the current is greater than the threshold (e.g., 210 A), the DSP 204 may set the switching sequence control signal 240 to cause the gate drive IC 202 to generate the switching signal 270 and the switching signal 260 such that the switching signal 260 rises earlier and falls later than the switching signal 270 during the switching cycle. Thus, the Si IGBT 206B is turned on earlier and turned off later than the SiC MOSFET 206A. Accordingly, under a high current condition, the Si IGBT 206B can be on for more of a switching cycle than the SiC MOSFET 206A. The hybrid traction inverter 102 can also ensure that the current is less than a second threshold (e.g., on the order of 100 Amperes) for safe operation when the current is greater than the threshold.

Advantageously, by turning on Si IGBTs 206B earlier than SiC MOSFETs 206A and turning off Si IGBTs 206B later than SiC MOSFETs 206A under operating conditions that correspond to higher current (e.g., greater than a threshold on the order of 100 Amperes) supply to or demand from the motor 104, the motor 104 may be more likely to receive sufficient current from the plurality of power switches 206. By turning on SiC MOSFETs 206A earlier than Si IGBTs 206B and turning off SiC MOSFETs 206A later than Si IGBTs 206B under operating conditions that correspond to lower current operating conditions associated with the motor 104, power conversion efficiency of the hybrid traction inverter 102 may be improved.

In some embodiments, during a switching cycle, the duration during which the SiC MOSFETs 206A and/or the Si IGBTs 206B are turned on may be on the order of 100 microseconds (us) or on the order of 1 μs. Depending on whether the sensed current exceeds the predetermined threshold, the switching sequence control signal 240 may set rising and falling edges of the switching signal 260 and the switching signal 270 to cause the SiC MOSFETs 206A to be turned on for a longer or a shorter duration than the Si IGBTs 206B by between 100 nanoseconds (ns) to 10 μs in a switching cycle. In some embodiments, under various current demands from the traction motor 104, the SiC MOSFETs 206A and the Si IGBTs 206B are all turned on during a switching cycle except that SiC MOSFETs 206A are turned on longer than the Si IGBTs 206B when a current demand is below the predetermined threshold, and that Si IGBTs 206B are turned on longer than the SiC MOSFETs 206A when a current demand exceeds the predetermined threshold.

In some embodiments, instead of generating multiple sets of control signals to individually control power devices, the DSP 204 can generate a single set of control signals (e.g., the PWM signal 230 and the switching sequence control signal 240) that will be used by the gate drive IC 202 to generate the switching signal 270 and the switching signal 260 for controlling the SiC MOSFETs 206A and Si IGBTs 206B. Additionally, the PWM signal 230 and the switching sequence control signal 240 do not have to be generated synchronously. Asynchronous control of these signals may be applicable. Further, the gate drive IC 202 may be implemented using circuitry that does not introduce pulse width distortion during generations of the switching signal 260 and the switching signal 270. Advantageously, the complexity of generating these control signals may be reduced.

### Example Waveforms Related to Semiconductor Protection Features

Power semiconductors in an inverter, regardless of Si IGBT or SiC MOSFET, can typically prevent one failure from cascading to other power devices within the inverter or other parts of a high voltage system. Protection features in a traction inverter include desaturation protection, soft turn-off, Miller clamping, and power supply undervoltage detection.

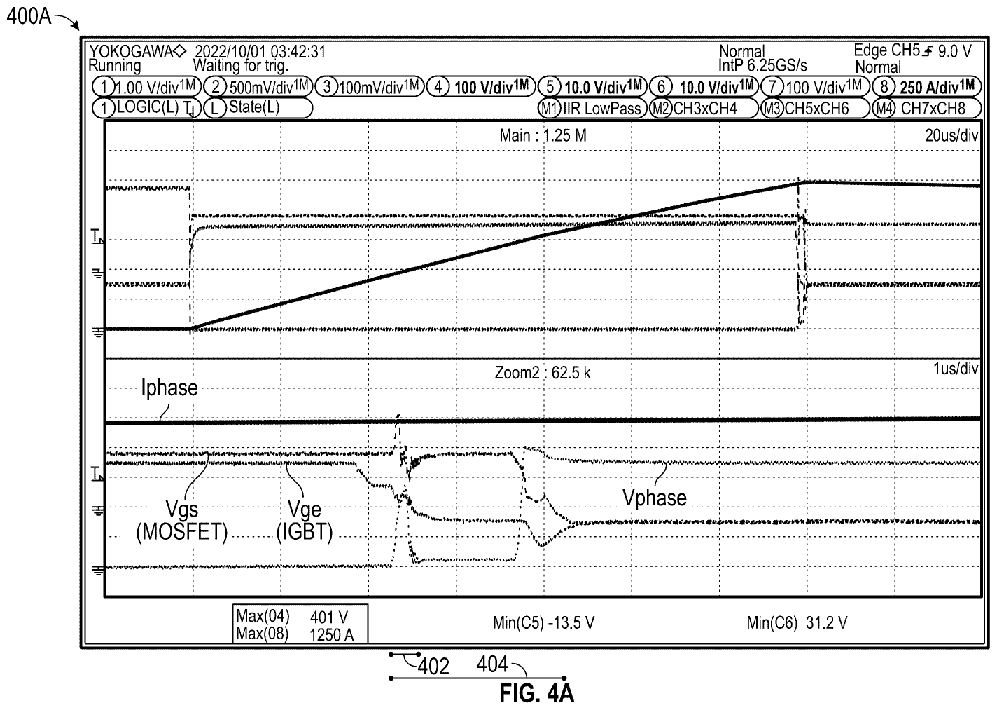

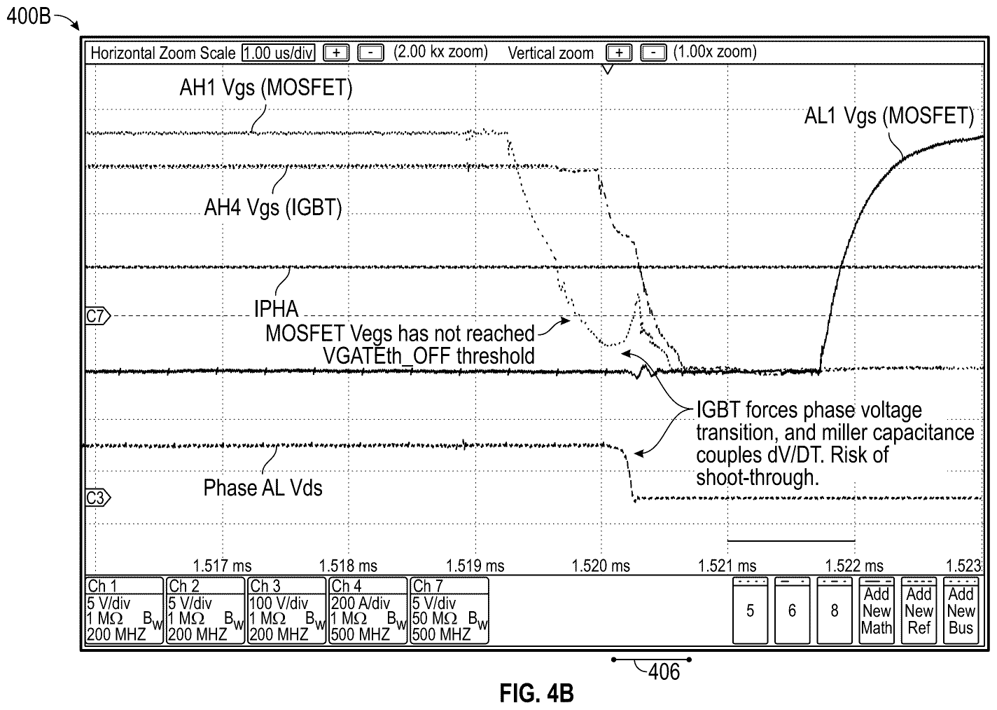

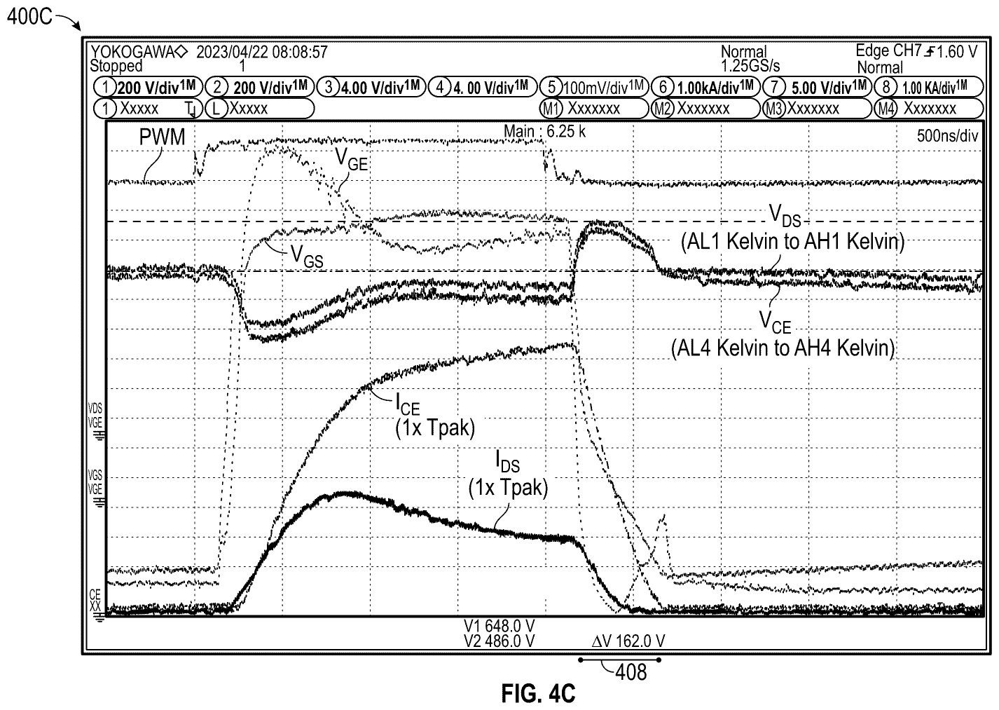

FIGS. 4A-4B show example waveforms associated with the plurality of power switches 206 of the hybrid traction inverter 102 to illustrate the need for certain protection circuits (e.g., the Miller clamping circuit 224, the desaturation protection circuit 226, and the Miller clamping circuit 228) in accordance with embodiments of the present disclosure.

FIG. 4A illustrates example waveforms 400A associated with the plurality of power switches 206. As shown in FIG. 4A, while turning off the SiC MOSFET 206A and the Si IGBT 206B as illustrated by a time period 404, transient voltage spike(s) may appear across the SiC MOSFET 206A and the Si IGBT 206B during an initial time period 402. For example, a spike may appear on a voltage (e.g., the “Vphase” shown in FIG. 4A) across the drain and the source of the SiC MOSFET 206A or across the collector and an emitter of the Si IGBT 206B. This appearance of a positive change of voltage may, if not properly handled, falsely activate the desaturation protection circuit 226.

As noted above, the desaturation protection circuit 226 may implement a masking mechanism to mask the spike so as to avoid undesired turn-off process. For example, during the time period 404, the desaturation protection circuit 226 may keep monitoring Vphase except during the initial time period 402. More specifically, the desaturation protection circuit 226 may include a comparator to generate a comparator output based on differences between Vphase and a desaturation threshold voltage during the time period 404. When Vphase is above the desaturation threshold voltage, the desaturation protection circuit 226 may activate or trigger a desaturation procedure to protect the plurality of power switches 206 from saturation. To avoid falsely triggering the desaturation procedure, the desaturation protection circuit 226 may ignore the comparator output generated during the initial time period 402. Alternatively, the desaturation protection circuit 226 may set the comparator output to a default value (e.g., logic zero to indicate Vphase does not exceed the desaturation threshold voltage) during the initial time period 402. As such, the spike on the Vphase during the initial time period 402 may not falsely activate the desaturation protection circuit 226 to trigger the desaturation procedure.

FIG. 4B illustrates example waveforms 400B associated with the plurality of power switches 206. More specifically, the waveforms 400B show voltage glitches on the gates of the SiC MOSFET 206A and the Si IGBT 206B due to Miller turn on effects. For example, due to Miller turn on effects, a glitch may appear on the voltage (e.g., the “Vgs” shown in FIG. 4B) across the gate and the source of the SiC MOSFET 206A during a time period 406. The hybrid traction inverter 102 may utilize the Miller clamping circuit 224 to mitigate the glitch. The hybrid traction inverter 102 may utilize the Miller clamping circuit 228 to mitigate Miller turn on effects or glitches at the gate of Si IGBT 206B. Advantageously, separately mitigating Miller turn on effects or glitches using distinct Miller clamping circuits (e.g., the Miller clamping circuit 224 and the Miller clamping circuit 228) enable the hybrid traction inverter 102 to activate clamping more effectively in view of differing characteristics of the SiC MOSFET 206A and the Si IGBT 206B.

FIG. 4C illustrates example waveforms 400C associated with the plurality of power switches 206 of the hybrid traction inverter 102 in accordance with embodiments of the present disclosure. For example, FIG. 4C shows that the SiC MOSFET 206A and the Si IGBT 206B are turned off at different speeds or rates during a time period 408. During the time period 408, a current (e.g., the ICE shown in FIG. 4C) provided by the Si IGBT 206B drops faster than a current (e.g., the Ips shown in FIG. 4C) provided by the SiC MOSFET 206A, indicating that the Si IGBT 206B is turned off more quickly than the SiC MOSFET 206A. In this example, the SiC MOSFET 206A may be turned off using a soft turn off process while the Si IGBT 206B may be turned off using a normal turn off process.

As noted above, the hybrid traction inverter 102 may μse the output circuit 234 and the output circuit 236 (shown in FIG. 2C) to allow the gate drive IC 202 to turn off the SiC MOSFET 206A and the Si IGBT 206B at different speeds as illustrated in FIG. 4C. The output circuit 234 and the output circuit 236 may be configurable to turn off the SiC MOSFETs 206A more slowly than the Si IGBTs 206B, or vice versa.

### Physical Layout and Design for Power Switches

To support mass manufacturing processes and low costs, traction inverters can μse multiple discrete devices in parallel. The power rating of an inverter can be adjustable by combining different numbers of discrete devices. Because of the physical interconnects involved in connecting parallel discrete devices, the parasitic inductance between devices can be non-negligible. Additionally, in a hybrid traction inverter with SiC MOSFETs creating high dl/dt switching events, hard-switching of Si IGBT anti-parallel diodes can create voltage across the parasitic inductance of interconnects between Si IGBTs and SiC MOSFETs. Voltage across these interconnects can affect on or more of reliability, efficiency, or the power capability of the inverter.

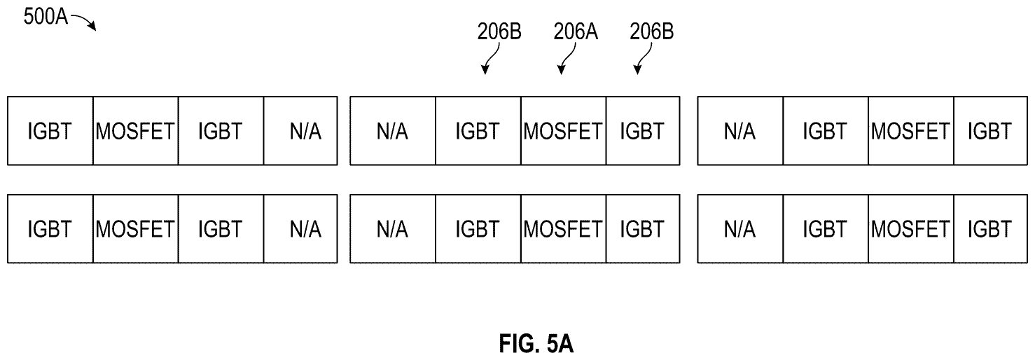

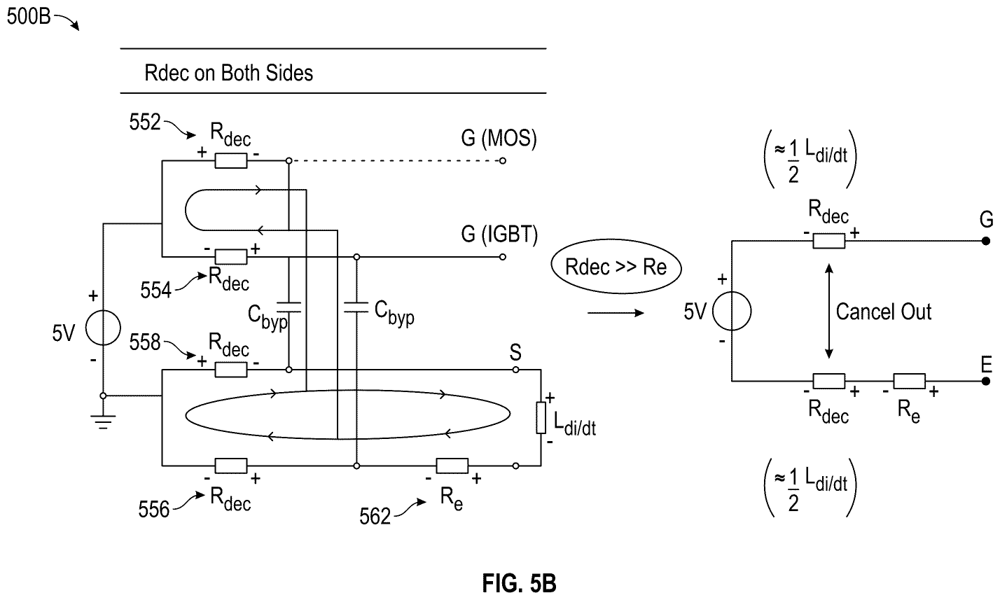

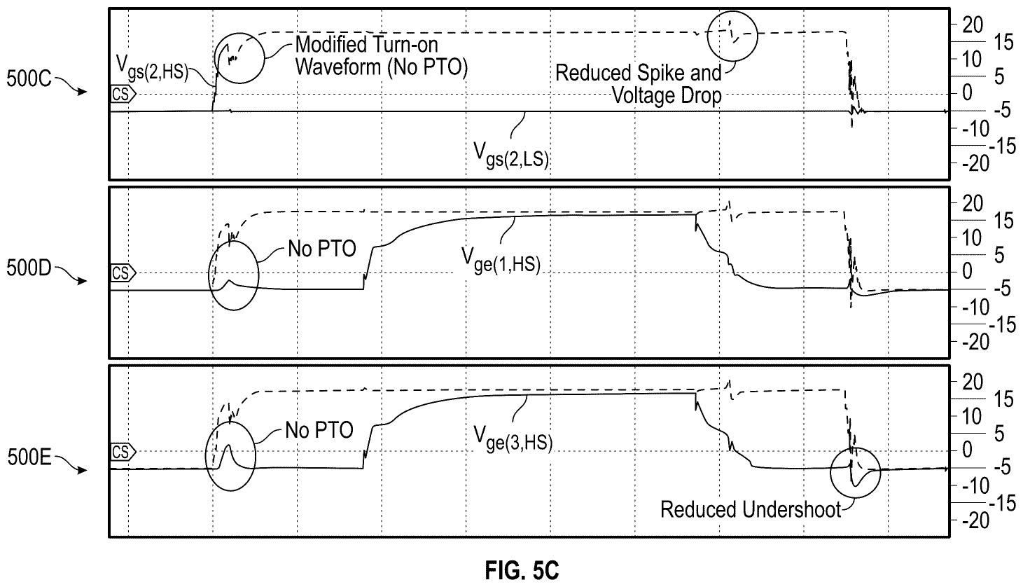

FIGS. 5A-5B illustrates various physical layout and circuit design techniques that may be employed by the hybrid traction inverter 102 to handle effects associated with parasitic capacitance and/or inductance resulting from physical interconnections between the plurality of power switches 206. The disclosed techniques may help improve reliability, efficiency, and/or power delivery capability of the hybrid traction inverter 102.

FIG. 5A illustrates a representation of a layout 500A of the plurality of power switches 206 of the hybrid traction inverter 102 in accordance with embodiments of the present disclosure. As shown in FIG. 5A, the layout 500A includes an arca accommodating Si IGBTs 206B, an arca accommodating SiC MOSFETs 206A, or unused placeholder positions (e.g., area labeled as “N/A”). As noted above, the physical symmetry of the plurality of power switches 206 in the layout 500A may help reduce or minimize voltage developed across interconnects of the plurality of power switches 206.

For example, the SiC MOSFET 206A may be positioned between two Si IGBTs 206B in the layout 500A. By placing Si IGBTs 206B symmetrically on opposing sides of the SiC MOSFET 206A, voltages developed across interconnects between the SiC MOSFET 206A and the Si IGBTs 206B can be reduced and/or become more balanced. More specifically, during high current variation (e.g., high dl/dt) switching events, voltage across the parasitic inductances of interconnects between IGBTs 206B and the MOSFET 206A may be reduced. Further, differences between switching waveforms applied to the Si IGBTs 206B in different positions may be reduced or eliminated because of the physical symmetry in the layout 500A.

As shown in FIG. 5A, the ratio between quantity of the Si IGBTs 206B and quantity of the SiC MOSFETs 206A may be a 2:1 ratio (e.g., two times the quantity of Si IGBTs 206B relative to the SiC MOSFET 206A). It should be noted that any other suitable ratio between quantity of the Si IGBTs 206B and are of the SiC MOSFETs 206A may be adopted by the hybrid traction inverter 102. Advantageously, through the specific placement and choice of relative number and/or area between SiC MOSFETs 206A and Si IGBTs 206B, power losses and thermal stress associated with the parasitic inductances between interconnects may be mitigated or controlled. Further, the empty or unoccupied areas shown in FIG. 5A (designated as “N/A”) may provide flexibility for scaling current driving capability of the hybrid traction inverter 102 through deploying additional Si IGBTs 206B and/or SiC MOSFETs 206A into these empty areas. The empty or unoccupied areas can be present in lower current inverters compared to inverters with fewer empty or unoccupied areas. In some examples, lower current inverters can have more empty or unpopulated areas in the physical layout. These empty areas (designated as “N/A” in the layout) can represent positions where additional power devices (e.g., Si IGBTs or SIC MOSFETs) could be installed if higher current handling were desired. In lower current applications, fewer devices may be used, so more of these positions can remain unfilled.

In the example 2:1 ratio discussed above, for every SiC MOSFET, there can be two Si IGBTs connected in parallel to share the current. This 2:1 ratio configuration can be used to balance or improve cost and current handling capability, as Si IGBTs are less expensive and better suited for high/fault current conditions, while SiC MOSFETs provide higher efficiency at lower loads. In some examples, the power devices can be mounted side-by-side on a common substrate or printed circuit board (PCB), with their terminals electrically connected in parallel (e.g., the collectors (or drains) are tied together, as are the emitters (or sources)). The physical layout can designed to be symmetrical, and can place the SiC MOSFET between two Si IGBTs to minimize parasitic effects and balance current distribution. In some examples, power switches (e.g., the Si IGBTs and SiC MOSFETs) are not directly mounted on a printed circuit board (PCB). Instead, the power switches can be mounted separately from the PCB, for example on a power module, heatsink, or other mechanical structure designed to handle high current and thermal loads. In these examples, the power switches can be electrically connected to the PCB via appropriate connectors or busbars. This arrangement can enable improved thermal management, easier replacement or scaling of power devices, and better accommodation of the high voltages and currents involved in traction inverter applications. The PCB, in these examples, primarily supports the gate drive IC and control circuitry, while the power switches themselves are physically and thermally isolated from the PCB. It should be noted that the emitters (for IGBTs) or sources (for MOSFETs) are not required to be all positioned on the same physical side. In some examples, the emitters and sources are electrically connected in parallel, and their physical placement may be interleaved or arranged symmetrically rather than grouped on one side.

In some examples, the empty or unoccupied areas (designated as “N/A”) in the layout can denote unused or unpopulated positions (e.g., dummy spaces that do not contain a power device). These areas can serve as placeholders for future expansion or to maintain symmetry in the physical layout, which helps manage parasitic inductance and thermal distribution. The presence of these areas allows for flexibility in scaling the inverter's current handling capability by adding more devices as needed, without requiring a complete redesign of the board or module.

FIG. 5B shows example schematics 500B associated with the plurality of power switches 206 of the hybrid traction inverter 102 in accordance with embodiments of the present disclosure. A decoupling circuit can decouple the high current drive circuits 208 and 210 from the power transistors. The decoupling circuit can add common mode impedance on power and signals associated with the high current drive circuits 208 and 210. The decoupling circuit can include decoupling impedances 552, 554, 556, and 558. As shown in FIG. 5B, a first decoupling impedance 554 (e.g., a resistor “Rdec”) may be connected to a gate of the Si IGBT 206B, and a second decoupling impedance 552 (e.g., a resistor “Rdec”) may be connected to a gate of the SiC MOSFET 206A. The first decoupling impedance 554 and the second decoupling impedance 552 may prevent or impede common mode voltages at the gates of the Si IGBT 206B and the SiC MOSFET 206A from converting into differential mode voltages at the gates, thereby reducing interference between the Si IGBT 206B and the SiC MOSFET 206A.

A third decoupling impedance 556 (e.g., a resistor) may be connected to an emitter of the Si IGBT 206B, and a fourth decoupling impedance 558 (e.g., a resistor) may be connected to a source of the SiC MOSFET 206A. The third decoupling impedance 556 and the fourth decoupling impedance 558 may prevent or impede common mode voltages at the emitter of the Si IGBT 206B and the source of the SiC MOSFET 206A from converting into differential mode voltages at the emitter and the source, thereby reducing interferences between the Si IGBT 206B and the SiC MOSFET 206A. Advantageously, mutual interferences between the SiC MOSFET 206A and the Si IGBT 206B caused by common mode voltages at terminals of the SiC MOSFET 206A and the Si IGBT 206B may be mitigated without utilizing independent power supply voltages for the SiC MOSFET 206A and the Si IGBT 206B.

FIG. 5B further shows that a balancing impedance 562 may be included in series with the decoupling impedance 556 for each of the Si IGBTs to balance current between the Si IGBTs 206B during switching transitions. The balancing impedance 562 may have a resistance smaller than a resistance of the decoupling impedance 556. In some examples, the balancing impedance 562 may have a resistance of less than 10 Ohms.

FIG. 5C illustrates example waveforms 500C, 500D, and 500E associated with the plurality of power switches 206 of the hybrid traction inverter 102 in accordance with embodiments of the present disclosure. More specifically, the waveforms 500C, 500D, and 500E illustrate that undesirable effects associated with parasitic capacitance and/or inductance resulting from physical interconnections between the SiC MOSFETs 206A and the Si IGBTs 206B are mitigated due to the various techniques described above with reference to FIGS. 5A-5B. For example, the waveform 500C illustrates that there are little or no parasitic turn-on (PTO) effects manifested at a gate of a SiC MOSFET 206A. Further, the waveform 500C illustrates that voltage spike and voltage drop at the gate of the SiC MOSFET 206A is reduced. The waveform 500D illustrates that there are little or no PTO effects manifested at a gate of a SiC MOSFET 206A. The waveform 500E illustrates that there are little or no PTO effects manifested at a gate of a SiC MOSFET 206A. Further, the waveform 500E illustrates that voltage undershoot during turning off of the SiC MOSFET 206A at the gate of the SiC MOSFET 206A is reduced.

### Example Flowchart

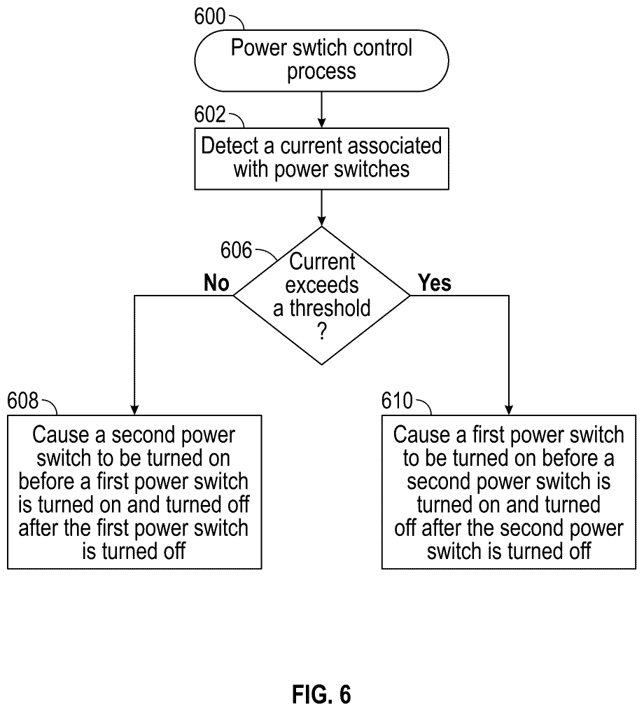

FIG. 6 illustrates an example power switch control process 600 (or simply referred to herein as a process) for controlling plurality of power switches 206 of the hybrid traction inverter 102 in accordance with embodiments of the present disclosure. The process 600 can improve efficiency or increase amount of current supplied by a traction inverter (e.g., the hybrid traction inverter 102) to a motor for driving an electric vehicle. The process 600 can be performed by the hybrid traction inverter 102 to adjust switch timings for the plurality of power switches 206 to supply current to the motor 104, depending on operating conditions associated with the motor 104.

The process 600 begins at block 602. At block 602, the hybrid traction inverter 102 detects or estimates a current associated with the plurality of power switches 206. More specifically, the current sensor 212 can sense a current supplied to the motor 104 by the plurality of power switches 206 to generate the sensing signal 280 indicative of the current. The current sensor 212 can sense the current using any suitable current sensing circuits and techniques. The current sensor 212 may transmit the sensing signal 280 to the DSP 204.

At decision block 606, the hybrid traction inverter 102 determines whether the current associated with the plurality of power switches 206 exceeds a threshold current. More specifically, the DSP 204 may determine that the current associated with the plurality of power switches 206 exceeds the threshold current. This can involve comparing the current to the threshold current. As noted above, the threshold current may be between two hundred to four hundred Amperes, or any other suitable range, depending on applications. The process 600 then varies according to whether the current associated with the plurality of power switches 206 exceeds, or in some cases is equal to, the threshold current. If the current associated with the plurality of power switches 206 does not exceed the threshold current, the process 600 proceeds to block 608.

At block 608, the hybrid traction inverter 102 generates switching signals to control the plurality of power switches 206 such that the SiC MOSFETs 206A are turned on earlier than the Si IGBTs 206B are turned on in a switching cycle and the SiC MOSFETs 206A are turned off later than the Si IGBTs 206B are turned off in the switching cycle. For example, the DSP 204 may generate the PWM signal 230 and set the switching sequence control signal 240 to cause the gate drive IC 202 to generate the switching signal 270 and the switching signal 260 such that the switching signal 270 rises earlier and falls later than the switching signal 260 during the switching cycle. Thus, the SiC MOSFETs 206A are turned on earlier and turned off later than the Si IGBTs 206B. The operations at block 608 correspond to the voltage waveforms of switching signals 260 and 270 under low current conditions from FIG. 3.

If at decision block 606 it is determined that the current associated with the plurality of power switches 206 exceeds the threshold current, the process 600 proceeds to block 610.

At block 610, the hybrid traction inverter 102 generates switching signals to control the plurality of power switches 206 such that the Si IGBTs 206B are turned on earlier than the SiC MOSFETs 206A are turned on in a switching cycle and the Si IGBTs 206B are turned off later than the SiC MOSFETs 206A are turned off in the switching cycle. For example, the DSP 204 may generate the PWM signal 230 and set the switching sequence control signal 240 to cause the gate drive IC 202 to generate the switching signal 270 and the switching signal 260 such that the switching signal 260 rises earlier and falls later than the switching signal 270 during the switching cycle. Thus, the Si IGBTs 206B are turned on earlier and turned off later than the SiC MOSFETs 206A. The operations at block 610 correspond to the voltage waveforms of switching signals 260 and 270 under high current conditions from FIG. 3.

Although not shown in FIG. 6, after causing the SiC MOSFETs 206A and the Si IGBTs 206B to be turned on or off using the switching signal 270 and the switching signal 260, the process 600 may return to block 602, where the hybrid traction inverter 102 (e.g., the current sensor 212) detects the current associated with the plurality of power switches 206 at a later time instant. Depending on the current detected later, the DSP 204 and the gate drive IC 202 may generate the switching signal 260 and the switching signal 270 of differing waveforms to adjust switching of the plurality of power switches 206. The operations at blocks 602 to 608 or 610 can be performed for each switching cycle of a hybrid traction inverter 102.

### Conclusion

The foregoing disclosure is not intended to limit the present disclosure to the precise forms or particular fields of μse disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a μser terminal. In the alternative, the processor device and the storage medium can reside as discrete components in a μser terminal.

The processes described herein or illustrated in the figures of the present disclosure may begin in response to an event, such as on a predetermined or dynamically determined schedule, on demand when initiated by a μser or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without μser input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A hybrid traction inverter for controlling an electric motor comprising:
a plurality of power switches configured to, in parallel, supply current to the electric motor of an electric vehicle, the plurality of power switches comprising a first power switch and a second power switch, the first power switch and the second power switch being of different types; and
a controller configured to:
determine that a current associated with the plurality of power switches exceeds a threshold current; and
responsive to determining that the current associated with the plurality of power switches exceeds the threshold current, control the plurality of power switches such that the first power switch turns on before the second power switch turns on during a switching cycle.

2. The hybrid traction inverter of claim 1, wherein the controller is configured to:
determine that the current associated with the plurality of power switches is less than the threshold current; and
responsive to determining that the current associated with the plurality of power switches is less than the threshold current, control the plurality of power switches such that the second power switch turns on before the first power switch turns on during a second switching cycle.

3. The hybrid traction inverter of claim 1, further comprising a current sensor in communication with the controller, the current sensor configured to detect the current associated with the plurality of power switches.

4. The hybrid traction inverter of claim 1, wherein the first power switch is an insulated gate bipolar transistor, and wherein the second power switch is a field effect transistor.

5. The hybrid traction inverter of claim 1, wherein the first power switch is a silicon insulated gate bipolar transistor (Si IGBT), and wherein the second power switch is a silicon carbide metal oxide semiconductor field effect transistor (SiC MOSFET).

6. The hybrid traction inverter of claim 5, wherein an emitter of the Si IGBT is connected to a source of the SiC MOSFET, and wherein a collector of the Si IGBT is connected to a drain of the SiC MOSFET.

7. The hybrid traction inverter of claim 1, wherein the controller comprises:
a processing circuit configured to determine that the current associated with the plurality of power switches exceeds the threshold current, and generate a control signal and a pulse-width modulation (PWM) signal; and
a gate drive integrated circuit (IC) configured to generate, based on the control signal and the PWM signal, (i) a first switching signal to switch the first power switch and (ii) a second switching signal to switch the second power switch, such that the first power switch is turned on before the second power switch is turned on during the switching cycle, and the first power switch is turned off after the second power switch is turned off during the switching cycle.

8. The hybrid traction inverter of claim 7, wherein a rising edge of the first switching signal rises earlier than a rising edge of the second switching signal by an amount of time in a range from one hundred nanoseconds to ten microseconds during the switching cycle.

9. The hybrid traction inverter of claim 8, wherein a falling edge of the first switching signal falls later than a falling edge of the second switching signal by an amount of time in a range from one hundred nanoseconds to ten microseconds during the switching cycle.

10. The hybrid traction inverter of claim 7, wherein the PWM signal and the control signal are asynchronous to each other.

11. The hybrid traction inverter of claim 7, wherein the first power switch is a silicon insulated gate bipolar transistor (Si IGBT), and the second power switch is a silicon carbide metal oxide semiconductor field effect transistor (SiC MOSFET), and wherein a gate of the Si IGBT is driven by the first switching signal, and a gate of the SiC MOSFET is driven by the second switching signal.

12. The hybrid traction inverter of claim 1, wherein responsive to determining that the current associated with the plurality of power switches exceeds the threshold current, the controller is configured to control the plurality of power switches such that the first power switch turns off after the second power switch turns off during the switching cycle.

13. The hybrid traction inverter of claim 7, wherein the threshold current is above 100 Amperes.

14. The hybrid traction inverter of claim 2, wherein responsive to determining that the current associated with the plurality of power switches is less than the threshold current, the controller is to control the plurality of power switches such that the second power switch turns off after the first power switch turns off during the second switching cycle.

15. The hybrid traction inverter of claim 7, further comprising a high current drive circuit configured to boost the first switching signal to drive a gate of the first power switch and boost the second switching signal to drive a gate of the second power switch.

16. The hybrid traction inverter of claim 15, wherein the high current drive circuit and the gate drive IC are positioned on a printed circuit board (PCB), and wherein the high current drive circuit is positioned external to the gate drive IC.

17. A method of switching a plurality of power switches configured to, in parallel, supply current to a motor of an electric vehicle, wherein the plurality of power switches comprise a first power switch and a second power switch of different types, the method comprising:
determining that a current associated with the plurality of power switches exceeds a threshold current; and
responsive to determining that the current associated with the plurality of power switches exceeds the threshold current, controlling the plurality of power switches such that the first power switch turns on before the second power switch turns on during a switching cycle.

18. The method of claim 17, further comprising:
determining that the current associated with the plurality of power switches is less than the threshold current; and
responsive to determining that the current associated with the plurality of power switches is less than the threshold current, controlling the plurality of power switches such that: (1) the second power switch turns on before the first power switch turns on during a second switching cycle, and (2) the second power switch turns off after the first power switch turns off during the second switching cycle.

19. The method of claim 17, further comprising detecting the current associated with the plurality of power switches.

20. An electric vehicle comprising:
a motor; and
a hybrid traction inverter configured to drive the motor, the hybrid traction inverter comprising:
a plurality of power switches configured to, in parallel, supply current to the motor, the plurality of power switches comprising a first power switch and a second power switch, the first power switch and the second power switch being of different types; and
a controller configured to:
determine that the current associated with the plurality of power switches exceeds a threshold current; and
responsive to determining that the current associated with the plurality of power switches exceeds the threshold current, control the plurality of power switches such that:
the first power switch turns on before the second power switch turns on during a switching cycle.
